(19) United States
(12) Patent Application Publication
(10) Pub. No.: US 2007/0216954 A1
(43) Pub. Date: Sep. 20, 2007

(54) High quality halftone process

(76) Inventor: Toshiaki Kakutani, Shiojiri-shi (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/725,064

(22) Filed: Mar. 15, 2007

(30) Foreign Application Priority Data
Mar. 17, 2006 (JP) 2006-74198

(51) Int. Cl. G06F 15/00

(52) U.S. Cl. 358/3.06; 358/1.9

(57) ABSTRACT

The invention provides a printing method of printing on a print medium. This method comprises: performing a halftone process on image data representing a tone value of each of pixels constituting an original image to generate dot data representing a status of dot formation on each of print pixels of a print image to be formed on the print medium; and generating the print image in response to the dot data, by mutually combining dots formed on print pixels belonging to each of a plurality of pixel position groups in a common print area, the plurality of pixel position groups assuming a physical difference each other at the dot formation. A condition for the halftone processing is configured such that at least one dot pattern among dot patterns has a given spatial frequency characteristic in a first predetermined specific direction on the printing medium for at least a part of the input tone values, each of the dot patterns being formed on the plurality of printing pixels belonging to each of the plurality of pixel groups.

### BACKGROUND

1. Field of the Invention

This invention relates to a technology for printing an image by forming dots on a printing medium.

2. Description of the Related Art

Printing devices that form dots on a printing medium to print out an image enjoy widespread use as output devices for images created on a computer, images shot with a digital camera, and the like. Since the tone values that can be formed by dots are fewer in number than the input tone values, such printing devices carry out tone representation by means of a halftoning process. One widely used halftoning process is a systematic dither process employing a dither matrix. With the systematic dither process, since dither matrix content has a large impact on picture quality, attempts have been made to optimize the dither matrix by means of the analysis techniques of genetic algorithms or simulated annealing using an evaluation coefficient that takes human vision into consideration, such as disclosed in JP-A-7-177351, JP-A-7-81190, and JP-A-10-329381 for example.

However, in optimization processes employing such dither matrices, ink dots are formed by means of multiple scans over a common area on the printing medium, and degradation of picture quality caused by printing of the image thereby was not taken into consideration. Such degradation of picture quality is not limited to halftoning processes that use a dither matrix, but occurs generally in printing whenever a halftoning process is utilized.

### SUMMARY

An advantage of some aspect of the present invention is to provide a technique for forming ink dots by means of multiple scans over a common area on the printing medium, and minimizing degradation of picture quality caused by printing of the image thereby.

According to an aspect of the invention, a printing method of printing on a print medium is provided. This method comprises: performing a halftone process on image data representing a tone value of each of pixels constituting an original image to generate dot data representing a status of dot formation on each of print pixels of a print image to be formed on the print medium; and generating the print image in response to the dot data, by mutually combining dots formed on print pixels belonging to each of a plurality of pixel position groups in a common print area, the plurality of pixel position groups assuming a physical difference each other at the dot formation. A condition for the halftone processing is configured such that at least one dot pattern among dot patterns has a given spatial frequency characteristic in a first predetermined specific direction on the printing medium for at least a part of the input tone values, each of the dot patterns being formed on the plurality of printing pixels belonging to each of the plurality of pixel groups.

The inventors have discovered for the first time the mechanism of degradation of picture quality caused by the organic relationship between these sorts of physical differences and the halftoning process. Specifically, it has been shown for the first time that, since conventional halftoning processes were designed focusing on the spatial frequency distribution of a printed image, in the event that, for example, the relative positions of a plurality of pixel groups combined together in a common printing area are shifted in unison by means of physical error of the printing device, the relative positions may be altered and excessive degradation of picture quality may result.

Meanwhile it is also true that, in the case of bidirectional printing for example, such shift occurs to an appreciable extent in the main scanning direction but not to any appreciable extent in the sub-scanning direction. Taking note of this fact, the inventors arrived at the idea of implementing the halftoning process with emphasis on assumed shift in the main scanning direction, to eliminate unnecessary adjustments resulting from assumed shift in the sub-scanning direction and provide enhanced optimality of the halftoning process.

The inventors were able to identify the following phenomenon. Specifically, if a low-frequency density state exists for dots formed in a multiplicity of pixel groups, then in the event that ink drops are ejected with overlap due to lag in the timing of dot formation, the phenomena of agglomeration of ink drops, excessive gloss, or bronzing will be produced at locations of high dot density, in turn producing differences in the image from locations of low dot density. A problem with such differences in an image is that they are readily noticeable to the human eye as image irregularities.

Meanwhile, such phenomena become more noticeable with decreasing pitch of pixels targeted for dot formation in main scans, but in some instances the pitch of the pixels targeted for dot formation in main scans will differ between a main scan and a sub-scan. Taking note of this fact, the inventors also arrived at the idea of implementing the halftoning process with emphasis on the assumed direction of small pitch of pixels targeted for dot formation in main scans, to eliminate unnecessary adjustments resulting from the assumed direction of large pitch and provide enhanced optimality of the halftoning process.

The halftone process using this dither matrix of the invention has a broad concept that includes a conversion table (or correspondence table) used to generate a dither matrix in technology such as that disclosed, for example, in Japanese Unexamined Patent Application 2005-236768 and Japanese Unexamined Patent Application 2005-269527, which teach the use of intermediate data (count data) for the purpose of identifying dot on-off state. Such conversion tables may be generated not only directly from dither matrices generated by the generation method of the invention, but in some instances may be subject to adjustments or improvements; such instances will also constitute use of a dither matrix generated by the generation method of the invention.

Note that the invention can be realized with various aspects including a printing device, a dither matrix, a dither matrix generating device, a printing device or printing method using a dither matrix, or a printed matter generating method, or can be realized with various aspects such as a computer program for realizing the functions of these methods or devices on a computer, a recording medium on which that computer program is recorded, data signals containing that computer program and embodied within a carrier wave, and the like.

Also, for use of the dither matrix for the printing device, printing method, or printed matter generating method, by comparing the threshold value set in the dither matrix with the image data tone value for each pixel, a decision is made of whether or not dots are formed for each pixel, but, for example, it is also possible to make a decision on whether or not dots are formed by comparing the sum of the threshold value and the tone value with a fixed value. Furthermore, it is also possible to make a decision on whether or not dots are formed according to data generated in advance based on the threshold value and on the tone value without directly using the threshold value. The dither method of the invention generally is acceptable as long as the judgment of whether or not to form dots is made according to the tone value of each pixel and on the threshold value set in the pixel position corresponding to the dither matrix.

### BRIEF DESCRIPTION OF THE DRAWINGS

FIG. 1 shows a block diagram of the structure of a printing system as an embodiment of the invention.

FIG. 2 shows a schematic structural diagram of color printer 20.

FIG. 3 shows an explanatory diagram that shows the nozzle array on the bottom surface of printing head 28.

FIG. 4 shows an exemplary conceptual illustration of part of a dither matrix.

FIG. 5 shows an illustration depicting the concept of dot on-off state using a dither matrix.

FIG. 6 shows an exemplary conceptual illustration of spatial frequency characteristics of threshold values established at pixels of a blue noise dither matrix having blue noise characteristics.

FIGS. 7A to 7C show conceptual illustrations of a visual spatial frequency characteristic VTF (Visual Transfer Function) representing sensitivity of the human visual faculty with respect to spatial frequency.

FIG. 8 shows an illustration depicting dot patterns produced using a conventional dither matrix.

FIG. 9 shows illustration depicting degradation of picture quality caused by bidirectional printing, in a printed image formed using a conventional dither matrix.

FIG. 10 shows illustration depicting minimization of picture quality degradation of a printed image formed by bidirectional printing, by means of the dither matrix of an embodiment of the invention.

FIG. 11 shows flowchart showing the processing routine of the dither matrix generation method in Embodiment 1 of the invention.

FIG. 12 shows an illustration depicting a dither matrix M subjected to the grouping process of grouping process of Embodiment 1, and two divided matrices M1, M2.

FIG. 13 shows an illustration depicting pixels targeted for dot formation during main scans in the course of bidirectional printing of Embodiment 1 of the invention.

FIG. 14 shows a flowchart showing the processing routine of the dither matrix evaluation process.

FIG. 15 shows an illustration depicting dots formed on each of eight pixels corresponding to elements storing threshold values associated with the first to eighth highest tendency to dot formation, in the dither matrix M.

FIG. 16 shows an illustration depicting a dot density matrix representing digitized dot density of a dot pattern of dots formed on each of nine pixels in the dither matrix M.

FIG. 17 shows an illustration depicting a dot pattern of five dots formed in the divided matrix M1.

FIG. 18 shows an illustration depicting a dot density matrix representing digitized dot density of a dot pattern of five dots formed in the divided matrix M1.

FIGS. 19A and 19B show illustrations of a two-dimensional filter characteristic expanded into a two-dimensional region, used for the purpose of calculating the two-dimensional graininess index for use in evaluating the divided matrices M1, M2.

FIGS. 20A and 20B show illustrations depicting anisotropy of the two-dimensional filter characteristic used in the embodiments of the invention, as observed from two locations in three-dimensional space.

FIG. 21 shows a flowchart depicting the processing routine of the dither matrix generation method (Step S300a) in Embodiment 2 of the invention.

FIG. 22 shows an illustration depicting group evaluation matrices DF0, DF1, DF3 generated by means of low-pass filter processing of all of dot density matrices DD0, DD1, DD3.

FIG. 23 shows an illustration depicting a computational equation for computing RMS granularity used in Embodiment 1 of the invention.

FIG. 24 shows an illustration depicting generation of a printed image on a printing medium by means of forming ink dots while performing single-direction main scanning and sub-scanning in a comparative example of the invention.

FIGS. 25A to 25D show illustrations depicting generation of a printed image by means of combining together, in a common printing area, dots formed on printing pixels belonging respectively to a plurality of pixel groups in the comparative example of the invention.

FIG. 26 shows an illustration depicting a printing method in which pixel pitch in the main scanning direction of pixels targeted for dot formation during main scans is smaller than pixel pitch in the sub-scanning direction.

FIG. 27 shows an illustration depicting a printing method in which pixel pitch in the sub-scanning direction of pixels targeted for dot formation during main scans is smaller than pixel pitch in the main scanning direction.

FIG. 28 shows an illustration depicting a flowchart of an example of application of the invention in an error diffusion method.

FIG. 29 shows an illustration depicting a Jarvis, Judice & Ninke error diffusion matrix, and an error diffusion total matrix Ma for carrying out cumulative error diffusion.

FIG. 30 shows an illustration depicting conditions of printing by a line printer having a plurality of print heads in a modification example of the invention.

FIGS. 31A to 31C show illustrations depicting an example of actual conditions of printing in a bidirectional printing system.

### DESCRIPTION OF THE PREFERRED EMBODIMENT

The preferred embodiments of the invention will be described below in the following order, for the purpose of providing a clearer understanding of the operation and working effects of the invention.

### A. Configuration of Printing Device in the Embodiments of the Invention:

### B. Generation of Optimal Dither Matrix Assuming Bidirectional Printing:

B-1. Picture Quality Degradation Caused by Bidirectional Printing and Mechanism for Inhibiting It:

B-2. Generation of Optimal Dither Matrix Based on Graininess Index (Embodiment 1):

B-3. Generation of Optimal Dither Matrix Based on RMS Granularity (Embodiment 2):

### C. Generation of Optimal Dither Matrix Assuming Dot Patterns Formed in Main Scans:

### D. Modification Examples:

### A. Configuration of Printing Device in the Embodiments of the Invention

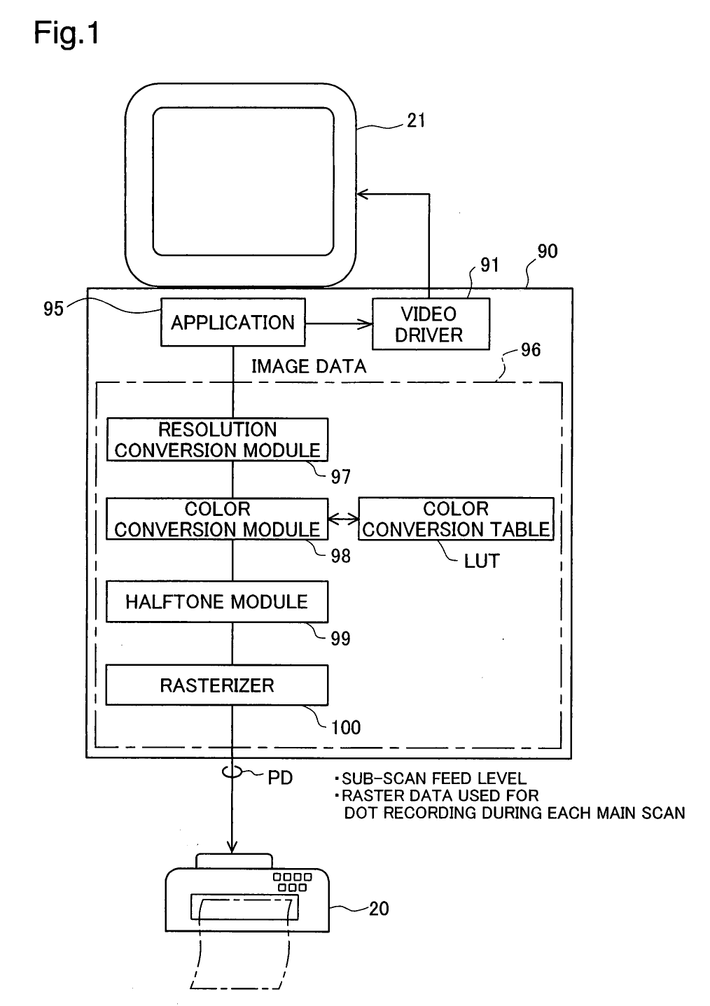

FIG. 1 shows a block diagram that shows the structure of a printing system as an embodiment of the invention. This printing system has a computer 90 as a printing control apparatus, and a color printer 20 as a printing unit. The combination of color printer 20 and computer 90 can be called a “printing apparatus” in its broad definition.

Application program 95 operates on computer 90 under a specific operating system. Video driver 91 and printer driver 96 are incorporated in the operating system, and print data PD to be sent to color printer 20 is output via these drivers from application program 95. Application program 95 performs the desired processing on the image to be processed, and displays the image on CRT 21 with the aid of video driver 91.

When application program 95 issues a print command, printer driver 96 of computer 90 receives image data from application program 95, and converts this to print data PD to supply to color printer 20. In the example shown in FIG. 1, printer driver 96 includes resolution conversion module 97, color conversion module 98, Halftone module 99, rasterizer 100, and color conversion table LUT.

Resolution conversion module 97 has the role of converting the resolution (in other words, the pixel count per unit length) of the color image data handled by application program 95 to resolution that can be handled by printer driver 96. Image data that has undergone resolution conversion in this way is still image information made from the three colors RGB. Color conversion module 98 converts RGB image data to multi-tone data of multiple ink colors that can be used by color printer 20 for each pixel while referencing color conversion table LUT.

The color converted multi-tone data can have a tone value of 256 levels, for example. Halftone module 99 executes halftone processing to express this tone value on color printer 20 by distributing and forming ink dots. Image data that has undergone halftone processing is realigned in the data sequence in which it should be sent to color printer 20 by rasterizer 100, and ultimately is output as print data PD. Print data PD includes raster data that shows the dot recording state during each main scan and data that shows the sub-scan feed amount.

Printer driver 96 is a program for realizing a function that generates print data PD. A program for realizing the functions of printer driver 96 is supplied in a format recorded on a recording medium that can be read by a computer. As this kind of recording medium, any variety of computer readable medium can be used, including floppy disks, CD-ROMs, opt-magnetic disks, IC cards, ROM cartridges, punch cards, printed items on which a code such a bar code is printed, a computer internal memory device (memory such as RAM or ROM), or external memory device, etc.

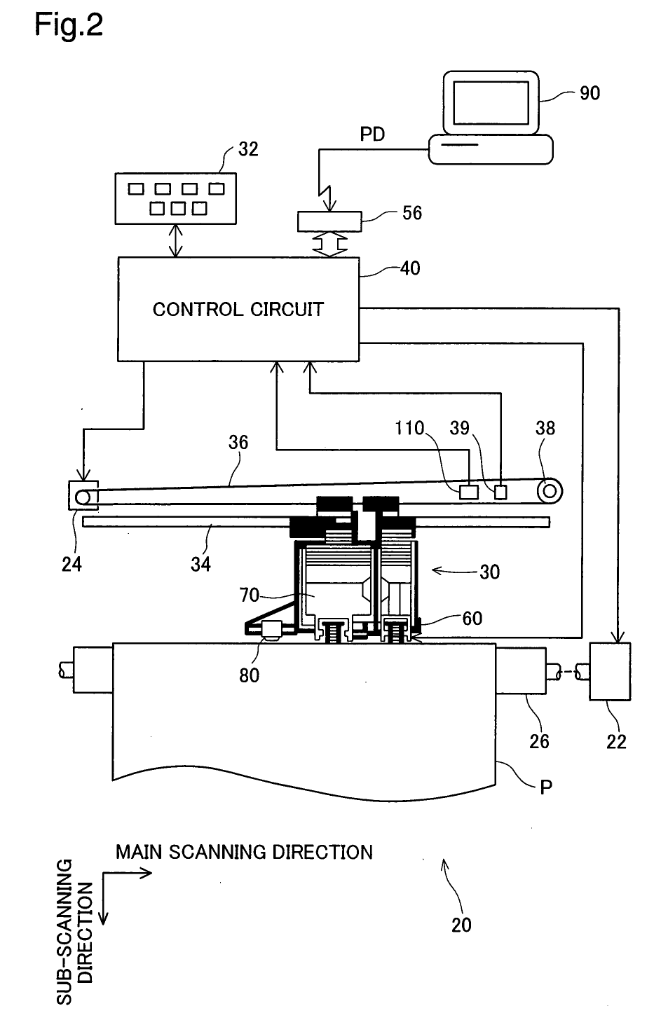

FIG. 2 shows a schematic structural diagram of color printer 20. Color printer 20 is equipped with a sub-scan feed mechanism that carries printing paper P in the sub-scanning direction using paper feed motor 22, a main scan feed mechanism that sends cartridge 30 back and forth in the axial direction of platen 26 using carriage motor 24, a head driving mechanism that drives printing head unit 60 built into carriage 30 and controls ink ejecting and dot formation, and control circuit 40 that controls the interaction between the signals of paper feed motor 22, carriage motor 24, printing head unit 60, and operating panel 32. Control circuit 40 is connected to computer 90 via connector 56.

The sub-scan feed mechanism that carries printing paper P is equipped with a gear train (not illustrated) that transmits the rotation of paper feed motor 22 to paper carriage roller (not illustrated). Also, the main scan feed mechanism that sends carriage 30 back and forth is equipped with sliding axis 34 on which is supported carriage 30 so that it can slide on the axis and that is constructed in parallel with the axis of platen 26, pulley 38 on which is stretched seamless drive belt 36 between the pulley and carriage motor 24, and position sensor 39 that detects the starting position of carriage 30.

Printing head unit 60 has printing head 28, and holds an ink cartridge. Printing head unit 60 can be attached and detached from color printer 20 as a part. In other words, printing head 28 is replaced together with printing head unit 60.

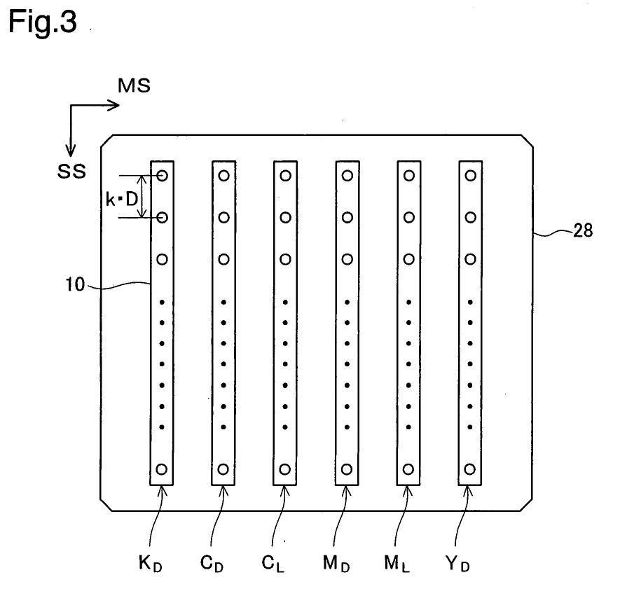

FIG. 3 shows an explanatory diagram that shows the nozzle array on the bottom surface of printing head 28. Formed on the bottom surface of printing head 28 are black ink nozzle group KD for ejecting black ink, dark cyan ink nozzle group CD for ejecting dark cyan ink, light cyan ink nozzle group CL for ejecting light cyan ink, dark magenta ink nozzle group MD for ejecting dark magenta ink, light magenta ink nozzle group ML for ejecting light magenta ink, and yellow ink nozzle group YD for ejecting yellow ink.

The upper case alphabet letters at the beginning of the reference symbols indicating each nozzle group means the ink color, and the subscript “D” means that the ink has a relatively high density and the subscript “L” means that the ink has a relatively low density.

The multiple nozzles of each nozzle group are each aligned at a fixed nozzle pitch k·D along sub-scanning direction SS. Here, k is an integer, and D is the pitch (called “dot pitch”) that correlates to the printing resolution in the sub-scanning direction. In this specification, we also say “the nozzle pitch is k dots.” The “dot” unit means the print resolution dot pitch. Similarly, the “dot” unit is used for sub-scan feed amount as well.

Each nozzle is provided with a piezoelectric element (not illustrated) as a drive component that drives each nozzle to ejects ink drops. Ink drops are ejected from each nozzle while printing head 28 is moving in main scan direction MS.

Color printer 20 that has the hardware configuration described above, while carrying paper P using paper feed motor 22, sends carriage 30 back and forth using carriage motor 24, and at the same time drives the piezoelectric element of printing head 28, ejects ink drops of each color to form ink drops and forms a multi-tone image on paper P.

### B. Generation of Optimal Dither Matrix Assuming Bidirectional Printing

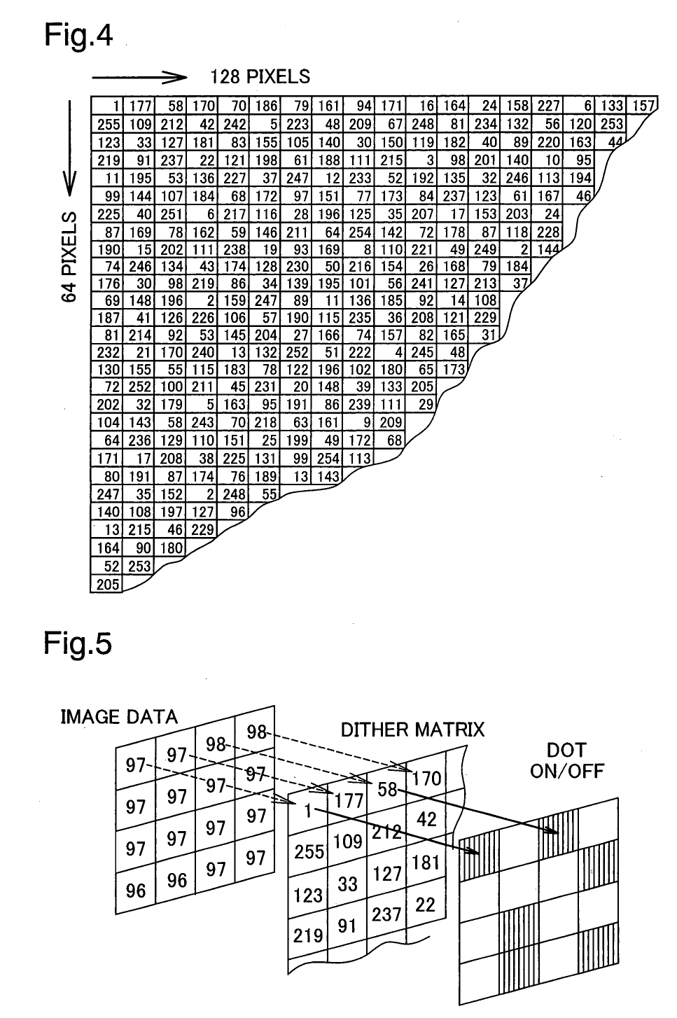

FIG. 4 shows an exemplary conceptual illustration of part of a dither matrix. In the illustrated matrix, threshold values selected uniformly from a tone value range of 1-255 are stored in a total of 8192 elements, i.e. 128 elements in the lateral direction (main scanning direction) by 64 elements in the vertical direction (sub-scanning direction). The size of the dither matrix is not limited to that shown by way of example in FIG. 4, and it is possible to have various sizes, including a matrix with an equal number of storage elements in both the vertical and lateral directions.

FIG. 5 shows an illustration depicting the concept of dot on-off state using a dither matrix. For convenience, only some of the elements are shown. As depicted in FIG. 2, when determining dot on-off states, tone values from the image data are compared with threshold values saved at corresponding locations in the dither matrix. In the event that a tone value from the image data is greater than the corresponding threshold value stored in the dither table, a dot is formed; whereas if the tone value from the image data is smaller, no dot is formed. Pixels shown with hatching in FIG. 2 signify pixels on which dots are formed. By using a dither matrix in this way, the dot on-off state can be determined on a pixel-by-pixel basis, by a simple process of comparing the tone values of the image data with the threshold values established in the dither matrix, making it possible to carry out the tone number conversion process rapidly. Furthermore, as will be apparent from the fact that once the tone values of the image data have been determined the decision as to whether to form dots on pixels will be made exclusively on the basis of the threshold values established in the matrix, and thus with a systematic dither process, it will be possible to actively control dot production conditions by means of the threshold value storage locations established in the dither matrix.

Since with a systematic dither process it is possible in this way to actively control dot production conditions by means of the threshold value storage locations established in the dither matrix, a resultant feature is that dot dispersion and other picture qualities can be controlled by means of adjusting setting of the threshold value storage locations. This means that by means of a dither matrix optimization process it is possible to optimize the halftoning process with respect to a wide variety of target states.

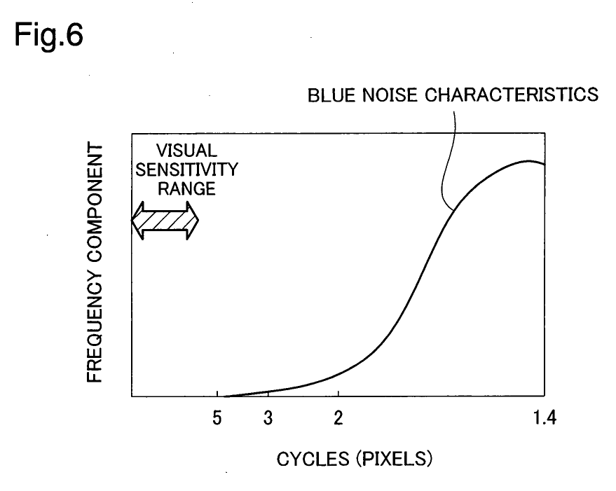

FIG. 6 shows an exemplary conceptual illustration of spatial frequency characteristics of threshold values established at pixels of a blue noise dither matrix having blue noise characteristics, by way of a simple example of dither matrix adjustment. The spatial frequency characteristics of a blue noise dither matrix are characteristics such that the length of one cycle has the largest frequency component in a high frequency region of 2 pixels or less. These spatial frequency characteristics have been established in consideration human perceptual characteristics. Specifically, a blue noise dither matrix is a dither matrix that, in consideration of the fact that human visual acuity is low in the high frequency region, has the storage locations of threshold values adjusted in such a way that the largest frequency component is produced in the high frequency region.

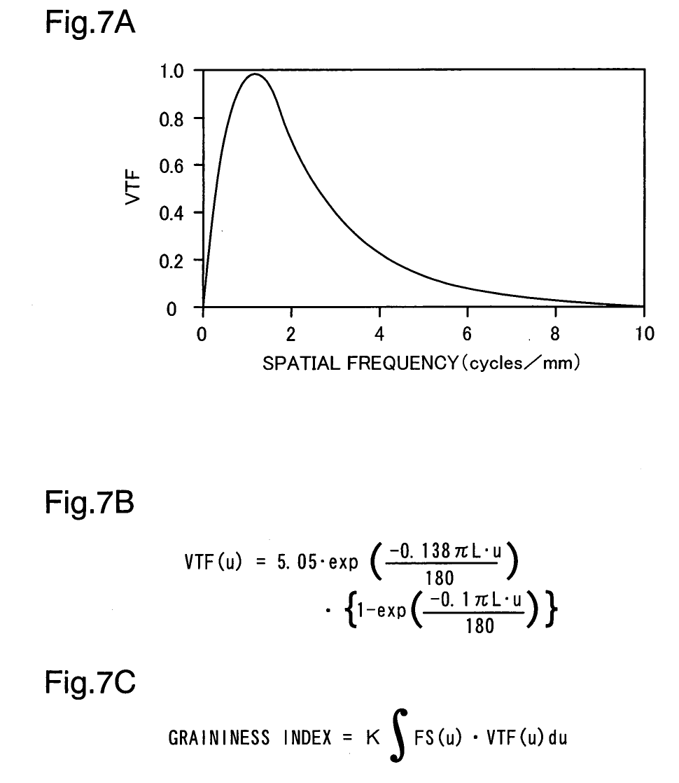

FIGS. 7A to 7C show a conceptual illustration of a visual spatial frequency characteristics VTF (Visual Transfer Function) representing human visual acuity with respect to spatial frequency. Where a visual spatial frequency characteristics VTF is used, it is possible to quantify the perception of graininess of dots which will be apparent to the human visual faculty following a halftoning process, by means of modeling human visual acuity using a transfer function known as a visual spatial frequency characteristics VTF. A value quantified in this manner is referred to as a graininess index. FIG. 7B gives a typical experimental equation representing a visual spatial frequency characteristics VTF. In FIG. 7B the variable L represents observation distance, and the variable u represents spatial frequency. FIG. 7C gives an equation defining a graininess index. In FIG. 7C the coefficient K is a coefficient for matching derived values with human acuity.

As a general rule, computation of the graininess index of two-dimensional printed images is accomplished by performing integration as shown in FIG. 7C on the frequency components of all directions on the printing medium. However, in the invention herein, a graininess index is calculated for an individual direction by means of limiting the range of integration shown in FIG. 7C to only some directions. It is possible for this individual direction graininess index to be used as an index for digitizing and evaluating the “one-dimensional spatial frequency characteristic” recited in the claims, as shall be discussed later.

Such quantification of graininess perception by the human visual faculty makes possible finely-tuned optimization of a dither matrix for the human visual system. Specifically, as the evaluation coefficient for the dither matrix it is possible to use a graininess evaluation value derivable by performing Fourier transformation on a dot pattern hypothesized when input tone values have been input to a dither matrix to derive a power spectrum FS, and after a filter process involving multiplying thereof by the visual spatial frequency characteristics VTF, integrating all of the input tone values (FIG. 7C). In this example, the aim is to achieve optimization where threshold value storage locations are adjusted so as to minimize the dither matrix evaluation coefficient.

In cases where printing resolution is sufficiently high and a peak appears in a region devoid of visual sensitivity, the dither matrix may be adjusted so as to have green noise characteristics rather than blue noise characteristics. In this case, by applying prescribed bias to the VTF function and a low-pass filter, described later, green noise characteristics can be imparted to the dither matrix. This prescribed bias can be produced by pseudo-reduction of the sensitivity of the VTF function in the peak frequency band of the green noise characteristics, for example.

### B. Generation of Optimal Dither Matrix Assuming Bidirectional Printing

Bidirectional printing refers to printing wherein an image is generated by forming dots on printing pixels during both forward passes and return passes during main scan advance of the print head 28 (herein referred to simply as “main scanning”). A dither matrix optimized for bidirectional printing is generated in the following manner, in order to minimize degradation of picture quality caused by bidirectional printing.

### B-1. Picture Quality Degradation Caused by Bidirectional Printing and Mechanism for Inhibiting it

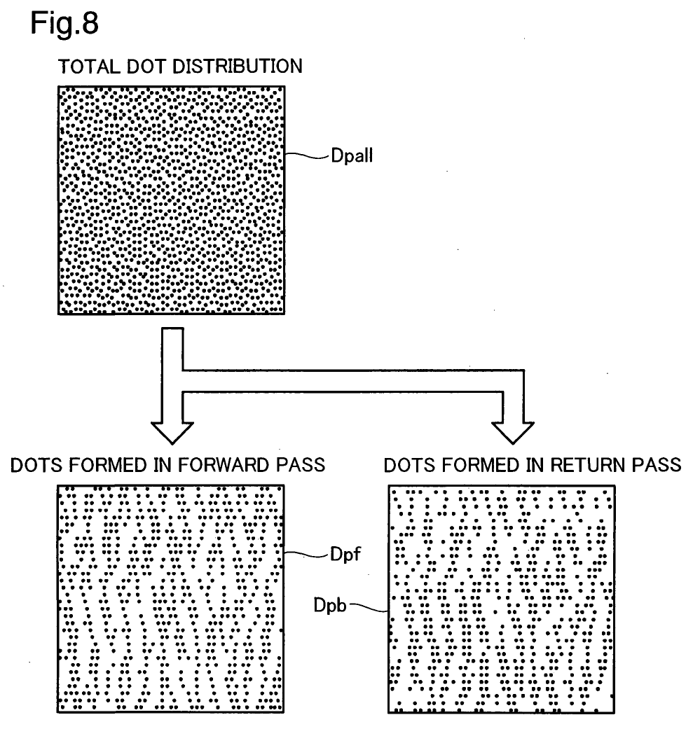

FIG. 8 is an illustration depicting dot patterns produced using a conventional dither matrix. In FIG. 8, three dot patterns Dpall, Dpf, and Dpb respectively show the dot pattern DPall of the printed image, the forward pass dot pattern Dpf formed during the forward pass of the main scan of the print head 28, and the return pass dot pattern Dpb formed during the return pass of the main scan of the print head 28. The dot pattern DPall of the printed image is formed by means of combining the forward pass dot pattern Dpf and the return pass dot pattern Dpb in a common printing area.

As will be apparent from FIG. 8, while the printed image dot pattern DPall has relatively uniform dispersion of dots, variable dot density levels occur in the forward pass dot pattern Dpf and the return pass dot pattern Dpb. Such variable dot density levels will be noticeable to the human eye as marked degradation of picture quality. While such degradation of picture quality is produced to some degree by designing the conventional dither matrix so as to improve the picture quality of the printed image dot pattern DPall, such degradation will not be manifested provided that the forward pass dot pattern Dpf and the return pass dot pattern Dpb are combined as hypothesized, with no error in dot formation location.

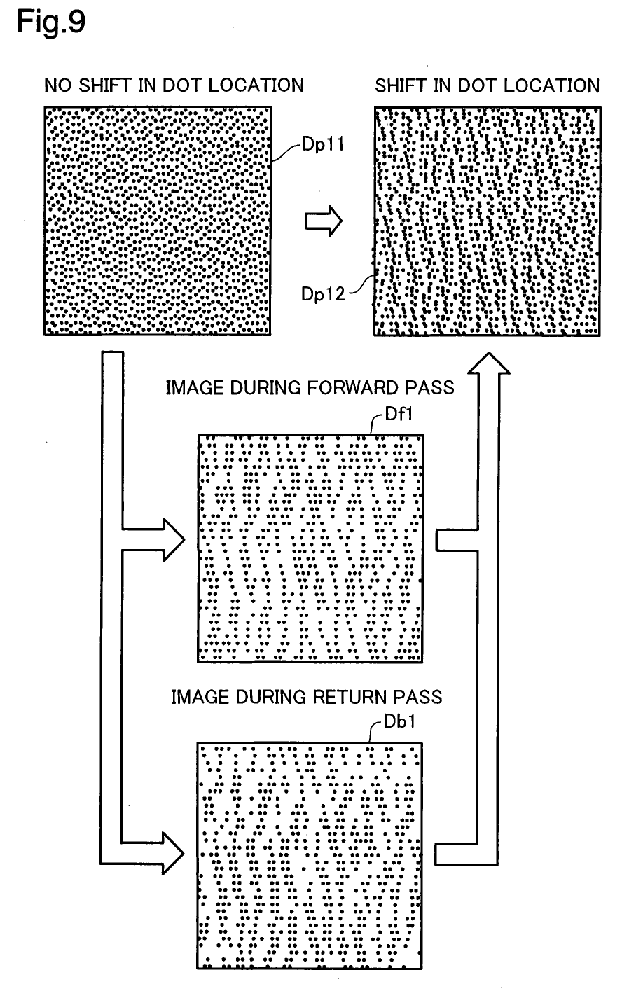

FIG. 9 is an illustration depicting degradation of picture quality caused by bidirectional printing, in a printed image formed using a conventional dither matrix. In FIG. 9, the four dot patterns Dp11, Dp12, Df1, Db1 respectively show the dot pattern Dp11 of the printed image (with no shift in dot locations), the dot pattern Dp12 of the printed image (with shift in dot locations), the forward pass dot pattern Df1 formed during the forward pass of the main scan of the print head 28, and the return pass dot pattern Db1 formed during the return pass of the main scan of the print head 28.

The printed image dot pattern Dp11 (with no shift in dot locations) is identical to the dot pattern Dpall of FIG. 8. The forward pass dot pattern Df1 is identical to the dot pattern Dpf of FIG. 8. The return pass dot pattern Db1 is identical to the dot pattern Dbp of FIG. 8.

In the printed image dot pattern Dp12 (with shift in dot locations), picture quality has been markedly degraded due to relative location shift between the forward pass dot pattern Df1 and the return pass dot pattern Db1. Relative shift of dot locations occurs due to shifting in unison of dot formation locations in main scanning direction in the individual dot patterns Df1, Db1, caused by the difference in the main scanning direction (forward or reverse) during dot formation. The reason that picture quality is markedly degraded by such relative location shift of the dot patterns is that, as mentioned previously, the conventional dither matrix has been designed on the assumption that dots will be formed at the correct locations, without location shift of this kind. Specifically, if there were no location shift, the high density areas and low density areas of each dot pattern Df1, Db1 would align precisely, thereby producing uniform dot dispersion; but since there are instances in which high density areas align with one another or low density areas align with one another due to location shift, in some instances high or low dot density will be emphasized, producing markedly degradation of picture quality.

On the basis of this hypothesis, the inventors demonstrated, by means of experimentation with various images, that such degradation of picture quality occurs due to bidirectional printing. Furthermore, on the basis of this hypothesis, the inventors arrived at the idea of a dither matrix that would be resistant (robust) with respect to location shift of dots.

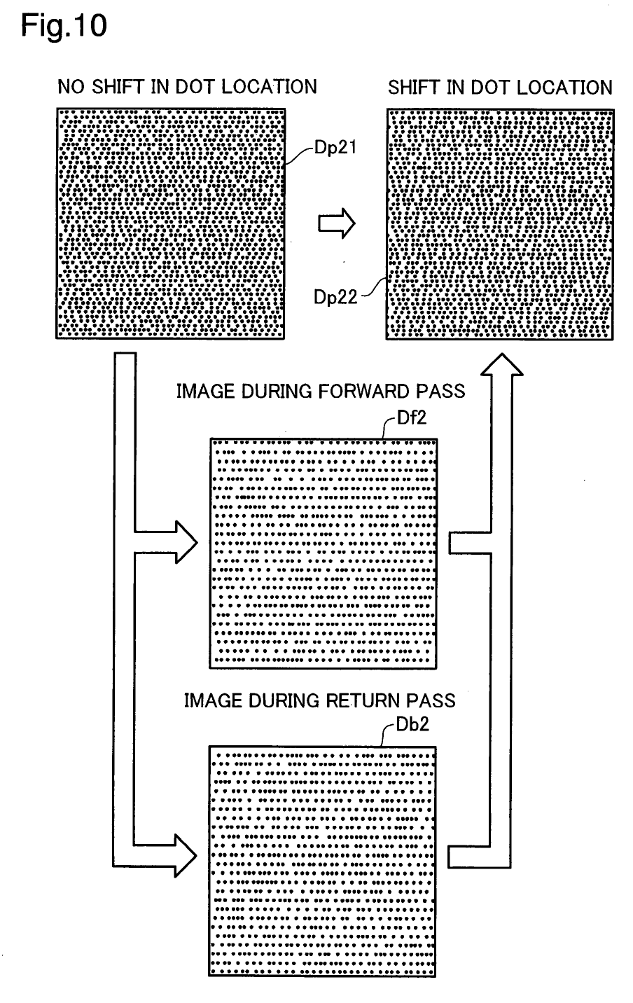

FIG. 10 is an illustration depicting minimization of picture quality degradation of a printed image formed by bidirectional printing, by means of the dither matrix of an embodiment of the invention. In FIG. 10, the four dot patterns Dp21, Dp22, Df2, Db2 respectively show the dot pattern Dp21 of the printed image (with no shift in dot locations), the dot pattern Dp22 of the printed image (with shift in dot locations), the forward pass dot pattern Df2 formed during the forward pass of the main scan of the print head 28, and the return pass dot pattern Db2 formed during the return pass of the main scan of the print head 28.

The dither matrix of the embodiment of the invention has been designed so as to afford good dispersion of dots of the forward pass dot pattern Df2 and the return pass dot pattern Db2, and differs from the dot patterns Df1, Db1 described previously in that the dot patterns Df2, Db2 have low variability of dot density level. In the printed image dot pattern Dp21 (with no shift in dot locations) produced by combining these dot patterns Df2, Db2 with low variability of dot density level, overlap of high density areas with one another or overlap of low density areas with one another due to location shift will necessarily be minimal, and dot dispersion will be good, with minimal variability of dot density level.

In this way, the inventors arrived at an idea that is the reverse of the conventional practice, namely, of designing the dither matrix to be robust against dot formation location error, rather than attempting to improve picture quality through higher accuracy of formation locations. Furthermore, the inventors were successful in achieving practical generation of a dither matrix having such characteristics.

### B-2. Generation of Optimal Dither Matrix Based on Graininess Index (Embodiment 1)

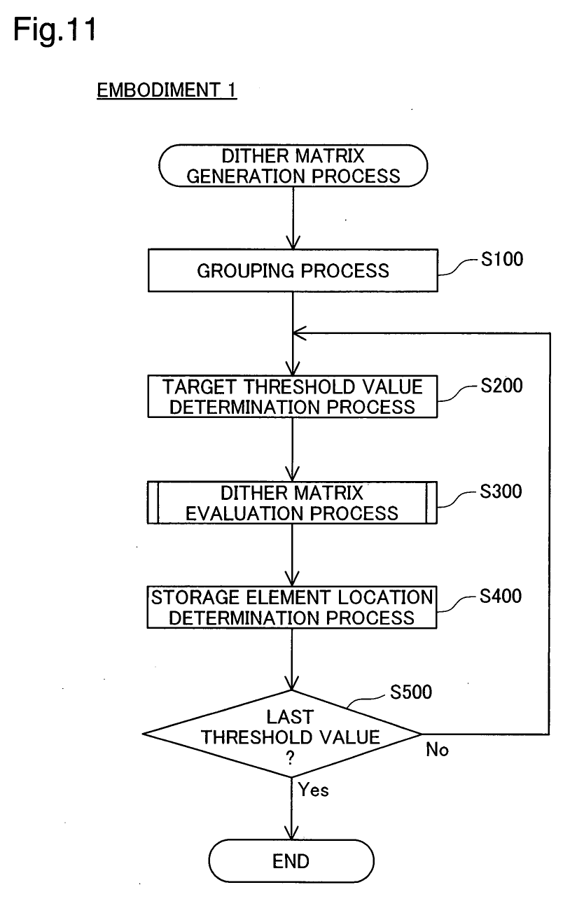

FIG. 11 is a flowchart showing the processing routine of the dither matrix generation method in Embodiment 1 of the invention. This dither matrix generation method is designed with the aim of optimization with consideration to dispersion of dots in both the forward pass and the return pass in the printed image forming process. In this example, to facilitate the discussion, generation of a small 8×8 dither matrix shall be described.

In Step S100, a grouping process is carried out. In the present embodiment, the grouping process is a process for dividing a dither matrix into individual elements corresponding to a pixel group of dots formed during the forward pass, and a pixel group of dots formed during the return pass, in the printed image forming process.

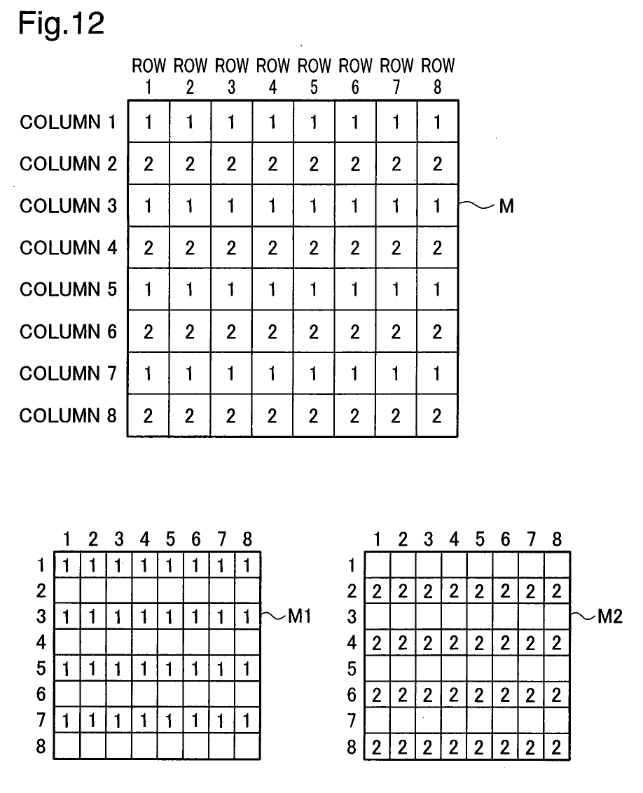

FIG. 12 is an illustration depicting a dither matrix M subjected to the grouping process of grouping process of Embodiment 1, and two divided matrices M1, M2. In this grouping process, division into two pixel groups is assumed. The numbers appearing on the elements of the dither matrix M indicate the pixel group to which the elements belong. In this example, elements in odd-numbered rows belong to the first pixel group, and elements in even-numbered rows belong to the second pixel group.

The divided matrix M1 is composed of a plurality of elements in the dither matrix M, which elements correspond to pixels that belong to the first pixel group, and a plurality of blank elements, which are elements that are blank. The divided matrix M2, on the other hand, is composed of a plurality of elements in the dither matrix M, which elements correspond to pixels that belong to the second pixel group, and a plurality of blank elements, which are elements that are blank. Such a grouping process may be established on the assumption of the following printing method.

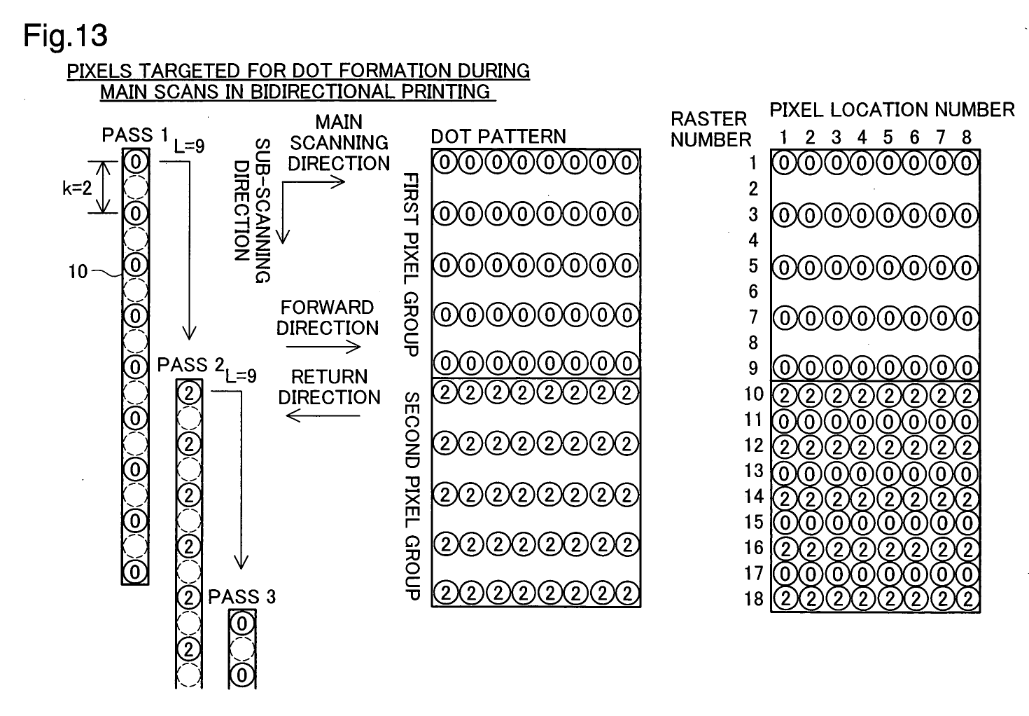

FIG. 13 is an illustration depicting pixels targeted for dot formation during main scans in the course of bidirectional printing of Embodiment 1 of the invention. In this printing method, dots are formed on pixels by means of bidirectional printing using a nozzle array 10. The nozzle array 10 is a nozzle array representative of the nozzle arrays K_{D}, C_{D}, C_{L}, M_{D}, M_{L}, Y_{D} formed on the lower face of the print head 28 (FIG. 3). The nozzle pitch k·D is 2D. Here, D denotes pixel pitch corresponding to the printing resolution in the sub-scanning direction.

In this bidirectional printing process, dots are formed on pixels in the following manner. During the initial main scan, denoted as Pass 1, the nozzle array 10 undergoes main scanning in the forward direction, forming dots at pixel locations. By so doing, dots are formed at pixel locations in odd-number rows, denoted by the number “1” in a circle. The group of pixels on which dots are formed in this way is designated as the first pixel group. After completing Pass 1, sub-scanning is performed, and then main scanning of Pass 2 is performed. In Pass 2, the nozzle array 10 undergoes main scanning in the reverse direction, forming dots at pixel locations. By so doing, dots are formed at pixel locations in even-number rows, denoted by the number “2” in a circle. The group of pixels on which dots are formed in this way is designated as the second pixel group.

Once the grouping process of Step S10 (FIG. 11) has been completed in this manner, the process advances to a targeted threshold value determination process (Step S200).

In Step S200, the targeted threshold value determination process is carried out. The target threshold value determination process is a process for determining a threshold value targeted for determination of a storage element therefor. In the present embodiment, threshold values are determined through selection in sequence, starting from threshold values with relatively small values, i.e. threshold values having values associated with high tendency to dot formation. The reason for doing so shall be discussed later.

In Step S300, a dither matrix evaluation process is carried out. The dither matrix evaluation process is a process for digitizing optimality of the dither matrix on the basis of a predetermined evaluation coefficients. In the present embodiment, the evaluation coefficients are the one-dimensional graininess index computed with the computational equation of FIG. 7C, and a two-dimensional graininess index defined by means of a computational equation representing this one-dimensional index in a two-dimensional region taking into consideration the direction of the printed image as well. The one-dimensional graininess index is used in evaluating the dither matrix M. The two-dimensional graininess index is used in evaluating the divided matrices M1, M2. The two-dimensional graininess index will be discussed in detail later.

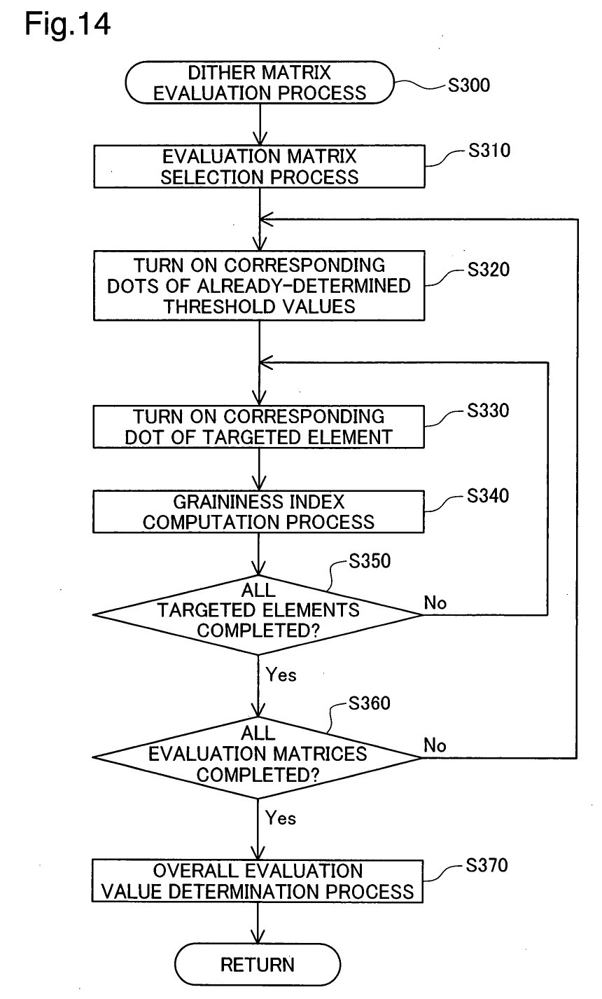

FIG. 14 is a flowchart showing the processing routine of the dither matrix evaluation process. In Step S310, an evaluation matrix selection process is performed. In the present embodiment, the evaluation matrix selection process is a process for selecting in sequence either of the two divided matrices M1, M2. For example, in the event that the divided matrix M1 has been selected, the divided matrix M1 and the dither matrix M would be targeted for assessment with the evaluation coefficients discussed previously.

In Step S320, the corresponding dots of already-determined threshold values are turned On. An already-determined threshold values refers to a threshold value for which a storage element has been determined. In the present embodiment, as mentioned earlier, since selection takes place in sequence starting from threshold values associated with high tendency to dot formation, when a dot is formed on a targeted threshold value, dots will invariably have been formed on those pixels that correspond to elements storing already-determined threshold values. Conversely, at the smallest input tone value at which a dot will form on the targeted threshold value, dots will not have been formed on pixels corresponding to any elements other than elements storing already-determined threshold values. In this example, the divided matrix M1 is assumed to be selected as the evaluation matrix.

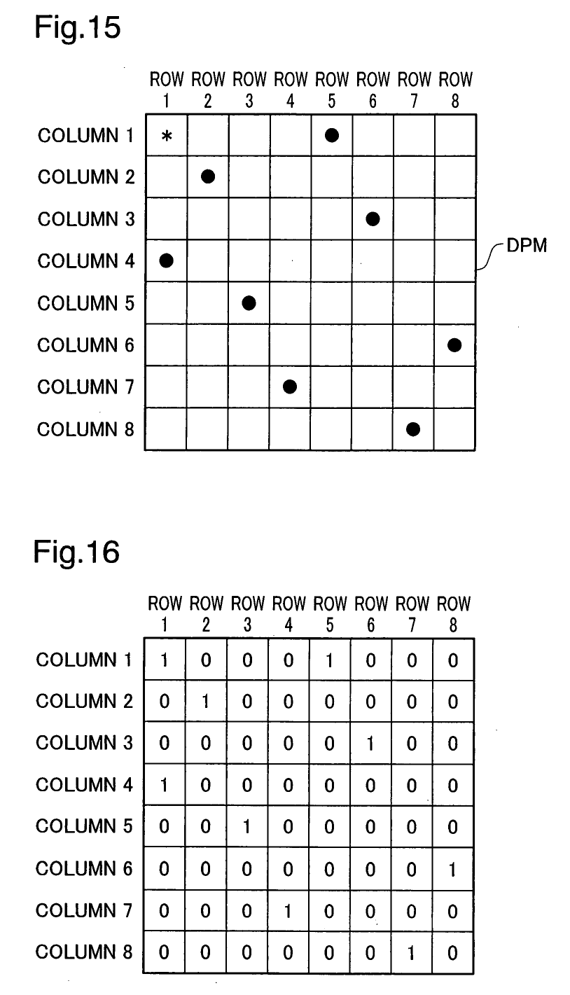

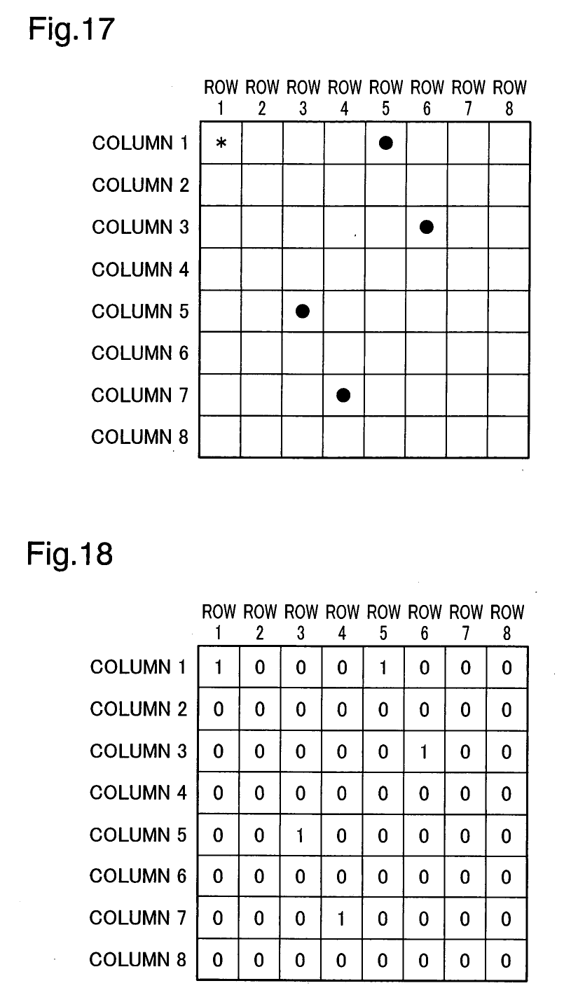

FIG. 15 is an illustration depicting a dot pattern DPM of dots (denoted by the symbol ) formed on each of eight pixels corresponding to elements in the dither matrix M in which are stored threshold values associated with the first to eighth highest tendency to dot formation. This dot pattern is used to determine the pixel on which the ninth dot should be formed. Specifically, it is used to determine the storage element for the targeted threshold value with the ninth highest tendency to dot formation. The * symbol denotes the pixel corresponding to the targeted element.

In Step S330, the corresponding dot of the targeted element is turned On. In this example, the targeted element is one of the candidate storage elements for the targeted threshold value associated with the ninth highest tendency to dot formation. Since the targeted element is selected from the elements of the evaluation matrix (in this example, the divided matrix M1), it will be selected from elements of odd-numbered rows.

In Step S340, a graininess index computation process is carried out. The graininess index computation process is a process whereby, using the computational equation given earlier, a graininess index is computed for the dot pattern DPM, on the assumption that a dot has been formed on the pixel corresponding targeted element. This process is carried out on the basis of a dot density matrix containing a digitized dot pattern (FIG. 16). In the dot density matrix containing the digitized dot pattern (FIG. 16), pixels on which dots have been formed have a value of “1,” and pixels on which dots have not been formed have a value of “0.”

While switching the targeted element, the processes of Step S330 and Step S340 are carried out for all of the pixels of the odd-numbered rows, except for the elements storing threshold values associated with the first to eighth highest tendency to dot formation.

The processes of Step S320-Step S350 are carried out similarly for the divided matrix M1 as well. However, the dot pattern targeted for evaluation here will be a dot pattern composed only of dots corresponding to elements of the divided matrix M1 and the dot corresponding to the targeted element. The corresponding dot density matrix is depicted in FIG. 18.

In Step S400 (FIG. 11), a storage element determination process is carried out. The storage element determination process is a process for determining a storage element for a targeted threshold value (in this example, the threshold value associated with the ninth highest tendency to dot formation). In the present embodiment, the storage element is determined from among elements having the smallest overall evaluation values. The overall evaluation values are computed by multiplying prescribed weights (e.g. 2:1) by the evaluation values of the dither matrix M and the divided matrices M1, M2, and adding them up.

Once this process has been performed for all threshold values, from the threshold value associated with the highest tendency to dot formation to the threshold value associated with the lowest tendency to dot formation, the dither matrix generation process terminates (Step S500).

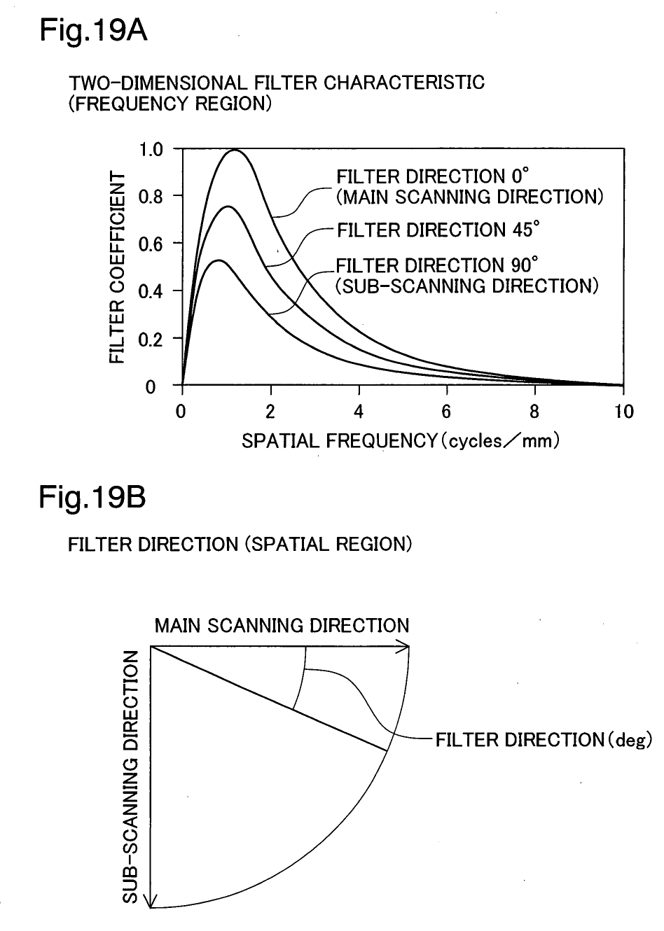

FIGS. 19A and 19B are illustrations of a two-dimensional filter characteristic expanded into a two-dimensional region, used for the purpose of calculating the two-dimensional graininess index for use in evaluating the divided matrices M1, M2. FIG. 19A depicts change in the filter coefficient versus spatial frequency, depending on direction on the printing medium. FIG. 19B is an illustration depicting the definition of direction on the printing medium. As will be understood from FIGS. 19A and 19B, the two-dimensional filter used in the embodiments of the invention is designed so that the filter coefficient increases moving closer to the main scanning direction.

This two-dimensional filter characteristic imparts directionality to the VTF function used in the conventional graininess index. In the conventional graininess index, through the use of the VTF function, graininess perception by the human visual faculty is quantified by means of increasing the weighting by the power spectrum FS in the frequency range where human visual sensitivity is high. This VTF function is assumed to be isotropic. That is, it is assumed that human visual sensitivity does not change depending on the direction of a printed image.

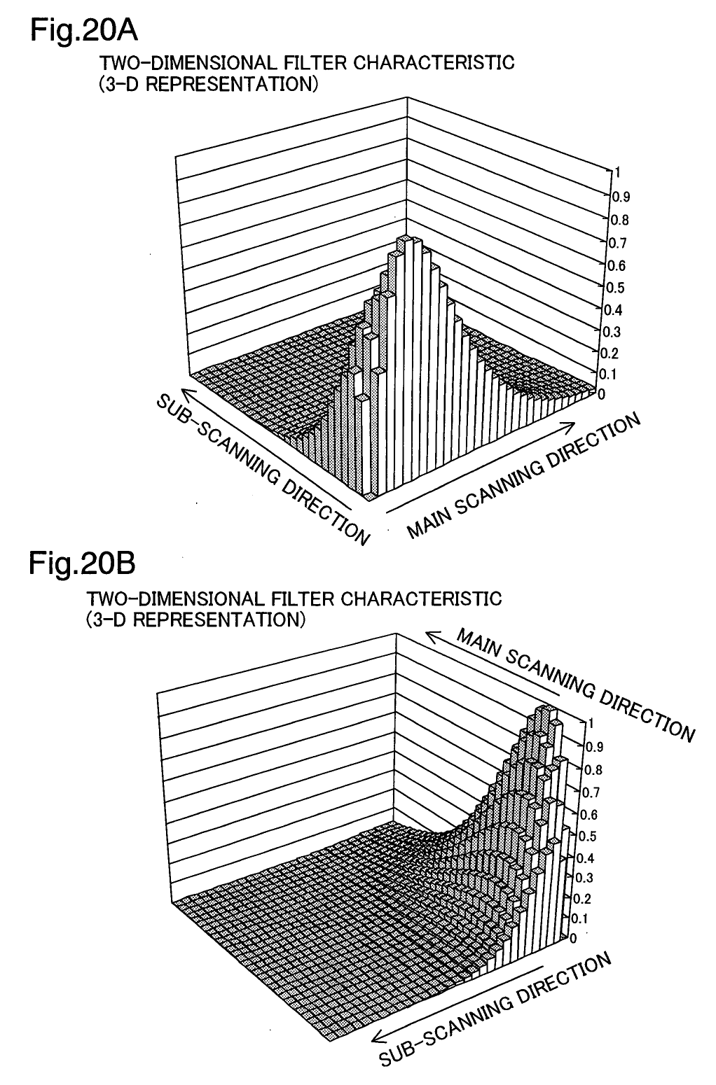

FIGS. 20A and 20B are illustrations depicting anisotropy of the two-dimensional filter characteristic used in the embodiments of the invention, as observed from two locations in three-dimensional space. This anisotropy is caused by bidirectional printing. In bidirectional printing, the forward pass dot pattern formed during the forward pass and the return pass dot pattern formed during the return pass tend to undergo relative shift in the main scanning direction, so the variable density level of these dot patterns in the main scanning direction is a significant cause of degraded picture quality. On the other hand, in the sub-scanning direction, while relative shift occurs due to factors such as vibration of the print head 28, this shift is very small in comparison with shift occurring in the main scanning direction.

Thus, it will be understood that the two-dimensional filter characteristic is designed so as to have anisotropy such that dot dispersion in the main scanning direction in the divided matrices M1, M2 is better than dot dispersion in the sub-scanning direction. This kind of anisotropy, by means of assigning relatively small weighting to dispersion of dots in the sub-scanning direction, has the effect of increasing the degree of freedom in design of all directions of the dither matrix M and the main scanning direction of the divided matrices M1, M2 making it possible to enhance optimality of the dither matrix

In this way, in accordance with Embodiment 1 of the invention, the intention is to optimize the dither matrix through the use of a two-dimensional filter characteristic having anisotropy, thus making it possible to effectively suppress granular appearance to the human visual faculty, by printed images produced by means of bidirectional printing.

Optimality of a dither matrix generated in accordance with Embodiment 1 of the invention can be verified by means of methods such as the following. These verification methods can provide verification of the inherent effects of the invention when the invention is implemented in a printing device.

The first method is one that focuses upon the coefficient of correlation between spatial frequency distributions of dot patterns. With this method, when the spatial frequency distributions of dot patterns are measured, there is objectively observed a tendency to increase on the part of the coefficient of correlation between the spatial frequency distribution of the dot pattern of the printed image and the spatial frequency distribution of the forward pass dot pattern or the return pass dot pattern, the closer the image data sampling direction is to the main scanning direction. This is because the two-dimensional graininess index has been designed so as to have identical or similar characteristics to the spatial frequency of the printed image in the main scanning direction.

The second method is one that focuses upon the graininess index in the direction of the forward pass dot pattern or the return pass dot pattern. With this method, when the spatial frequency distributions of dot patterns are measured, there is objectively observed a tendency to decrease on the part of the one-dimensional graininess index of the forward pass dot pattern or the return pass dot pattern, the closer the image data sampling direction is to the main scanning direction. This is because the two-dimensional graininess index has been designed so as to have the highest weighting in the main scanning direction, so that a dither matrix optimized on the basis of evaluation of the two-dimensional graininess index will form a dot pattern in which the one-dimensional graininess index is smallest in the main scanning direction.

The third method is one that focuses upon the combination (with shifting) of the forward pass dot pattern and the return pass dot pattern. With this method, when the forward pass dot pattern and the return pass dot pattern are scanned by a scanner, then combined while shifting them in the main scanning direction or the sub-scanning direction, there is objectively observed a tendency for picture quality to become markedly degraded in association with shift in the sub-scanning direction, as opposed to the minimal degradation in picture quality observed with shift in the main scanning direction. This is based on the objective feature directly linked to the effects of the invention, and the inherent effects of the invention are achieved on the basis of features such as this.

In this way, in accordance with Embodiment 1 of the invention, through control of dispersion of the dot pattern formed during the forward pass and the dot pattern formed during the return pass, with emphasis placed on dispersion thereof in the main scanning direction, it is possible to form novel printed images different from conventional ones, and to achieve printing that is robust against shift of relative position of the two dot patterns in the main scanning direction caused by bidirectional printing. In the present embodiment, the main scanning direction corresponds to the “specific direction” recited in the claims.

### B-3. Generation of Optimal Dither Matrix Based on RMS Granularity (Embodiment 2)

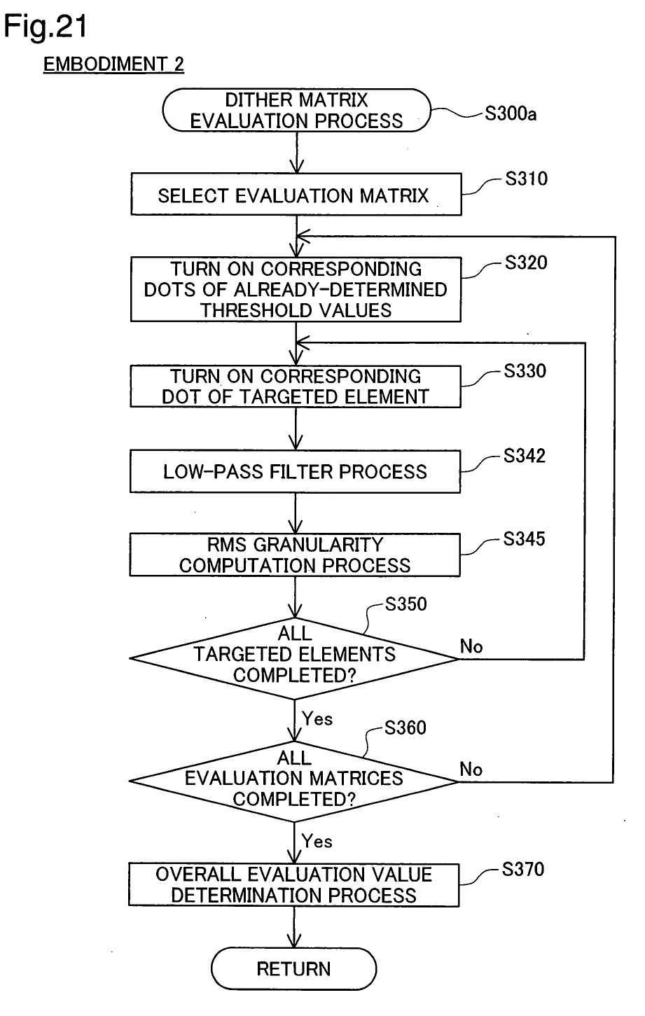

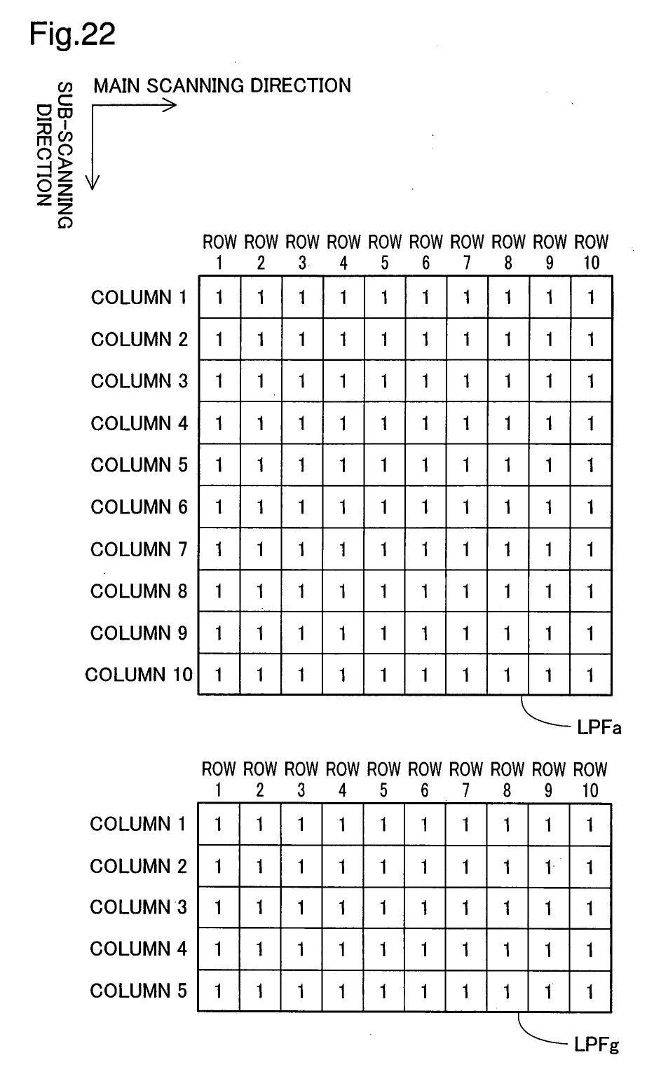

FIG. 21 is a flowchart depicting the processing routine of the dither matrix generation method (Step S300a) in Embodiment 2 of the invention. In the generation method of Embodiment 2, the dither matrix evaluation function differs from that of the dither matrix generation method of Embodiment 1. Specifically, the generation method of Embodiment 2 differs from the generation method of Embodiment 1 in that storage elements are determined on the basis of specific RMS granularity, rather than a one-dimensional or two-dimensional graininess index.

The generation method of Embodiment 2 may be accomplished by replacing the step of Step S340 (graininess detection process) with the step of Step S342 (low-pass filter process) and the step of Step S345 (RMS granularity computation process).

In Step S342, a low-pass filter process is performed on a dot density matrix corresponding to the dither matrix M or a divided matrix (FIG. 16, FIG. 18). For the dither matrix M, the low-pass filter process is performed using an isotropic low-pass filter LPFa. For the divided matrices M1, M2, on the other hand, the low-pass filter process is performed using an anisotropic low-pass filter LPFg of large matrix size in the main scanning direction. The reason for using an anisotropic low-pass filter LPFg of large matrix size in the main scanning direction for the divided matrices M1, M2 is for the purpose of improving dispersion in the main scanning direction of dot patterns corresponding to the divided matrices M1, M2.

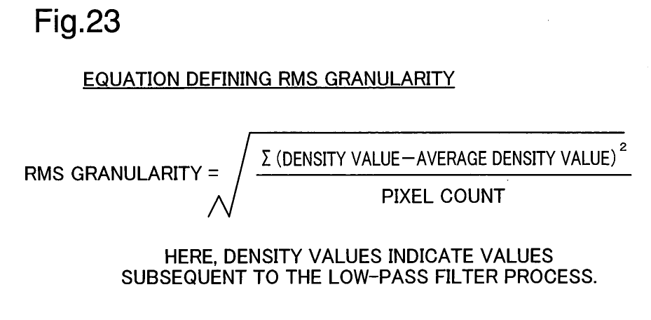

In Step S335, an RMS granularity computation process is carried out. The RMS granularity computation process is a process for computing standard deviation, subsequent to the low-pass filter process of the dot density matrix. Computation of the standard deviation can be carried out using the computational equation given in FIG. 23. Also, computation of the standard deviation need not necessarily be done for a dot pattern corresponding to all elements of the dither matrix M; in order to reduce the amount of computations, it would be possible to carry out the process using only dot density for pixels belonging to a prescribed window (e.g. a 5×5 partial matrix). This process is carried out for all of the targeted pixels (Step S350).

Values computed by this process are processed in the same manner as in Embodiment 1, thereby determining storage elements for targeted threshold values (S400 (FIG. 11)). In this way, through the use of an anisotropic low-pass filter, a similar process can be carried out using RMS granularity.

### C. Generation of Optimal Dither Matrix Assuming Dot Patterns Formed in Main Scans

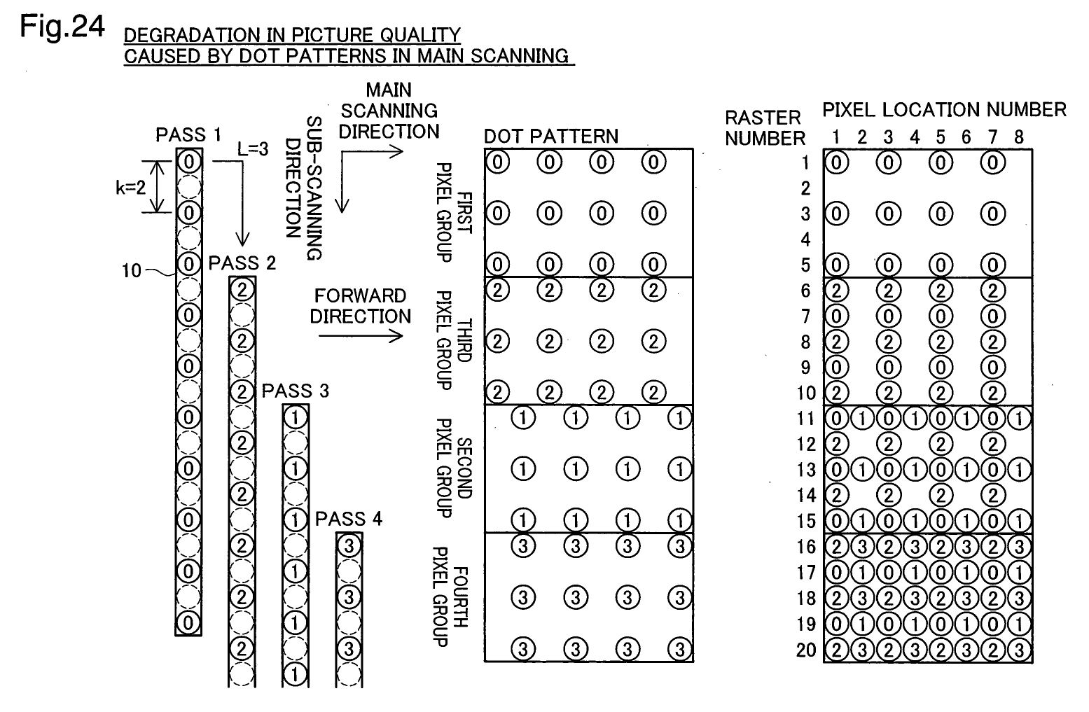

FIG. 24 is an illustration depicting generation of a printed image on a printing medium by means of forming ink dots while performing unidirectional main scanning and sub-scanning in a comparative example of the invention. Main scanning refers to the operation of relative motion of the nozzle array 10 in the main scanning direction, with respect to the printing medium. Sub-scanning refers to the operation of relative motion of the nozzle array 10 in the sub-scanning direction, with respect to the printing medium. The nozzle array 10 is designed to eject ink drops onto the printing medium to form ink dots. The nozzle array 10 is furnished with ten nozzles, not shown, spaced apart at intervals equal to twice the pixel pitch k. In this example, since printing is unidirectional, shift in the main scanning direction is minimal and is unlikely to cause degradation of picture quality. However, degradation of picture quality does occur due to lags in the timing of dot formation.

Generation of the print image is performed as follows while performing main scanning and sub scanning. Among the ten main scan lines of raster numbers 1, 3, 5, 7, 9, 11, 13, 15, 17, and 19, ink dots are formed at the pixels of the pixel position numbers 1, 3, 5, and 7. The main scan line means the line formed by the continuous pixels in the main scan direction. Each circle indicates the dot forming position. The number inside each circle indicates the pixel groups configured from the plurality of pixels for which ink dots are formed simultaneously. With pass 1, dots are formed on the print pixels belong to the first pixel group.

When the pass 1 main scan is completed, the sub scan sending is performed at a movement volume L of 3 times the pixel pitch in the sub scan direction. Typically, the sub scan sending is performed by moving the print medium, but with this embodiment, the nozzle array 10 is moved in the sub scan direction to make the description easy to understand. When the sub scan sending is completed, the pass 2 main scan is performed.

With the pass 2 main scan, among the ten main scan lines for which the raster numbers are 6, 8, 10, 12, 14, 16, 18, 20, 22, and 24, ink dots are formed at the pixels for which the pixel position number is 1, 3, 5, and 7. Working in this way, with pass 2, dots are formed on the print pixels belonging to the third pixel group. Note that the two main scan lines for which the raster numbers are 22 and 24 are omitted in the drawing. When the pass 2 main scan is completed, after the sub scan sending is performed in the same way as described previously, the pass 3 main scan is performed.

With the pass 3 main scan, among the ten main scan lines including the main scan lines for which the raster numbers are 11, 13, 15, 17, and 19, ink dots are formed on the pixels for which the pixel position numbers are 2, 4, 6, and 8. With the pass 4 main scan, among the ten main scan lines including the three main scan lines for which the raster numbers are 16, 18, and 20, ink dots are formed on the pixels for which the pixel position numbers are 2, 4, 6, and 8. Working in this way, we can see that it is possible to form ink dots without gaps in the sub scan position from raster number 15 and thereafter. With pass 3 and pass 4, dots are formed on the print pixels belonging respectively to the second and fourth pixel groups.

When monitoring this kind of print image generation focusing on a fixed area, we can see that this is performed as noted below. For example, when the focus area is the area of pixel position numbers 1 to 8 with the raster numbers 15 to 19, we can see that the print image is formed as noted below at the focus area.

With pass 1, at the focus area, we can see that a dot pattern is formed that is the same as the ink dots formed at the pixel positions for which the pixel position numbers are 1 to 8 with the raster numbers 1 to 8. This dot pattern is formed by dots formed at the pixels belonging to the first pixel group. Specifically, with pass 1, for the focus area, dots are formed at pixels belonging to the first pixel group.

With pass 2, at the focus area, dots are formed at the pixels belonging to the third pixel group. With pass 3, at the focus area, dots are formed at the pixels belonging to the second pixel group. With pass 4, at the focus area, dots are formed at the pixels belonging to the fourth pixel group.

In this way, with this embodiment, we can see that the dots formed at the print pixels belonging to each of the plurality of first to fourth pixel groups are formed by mutually combining at the common print area.

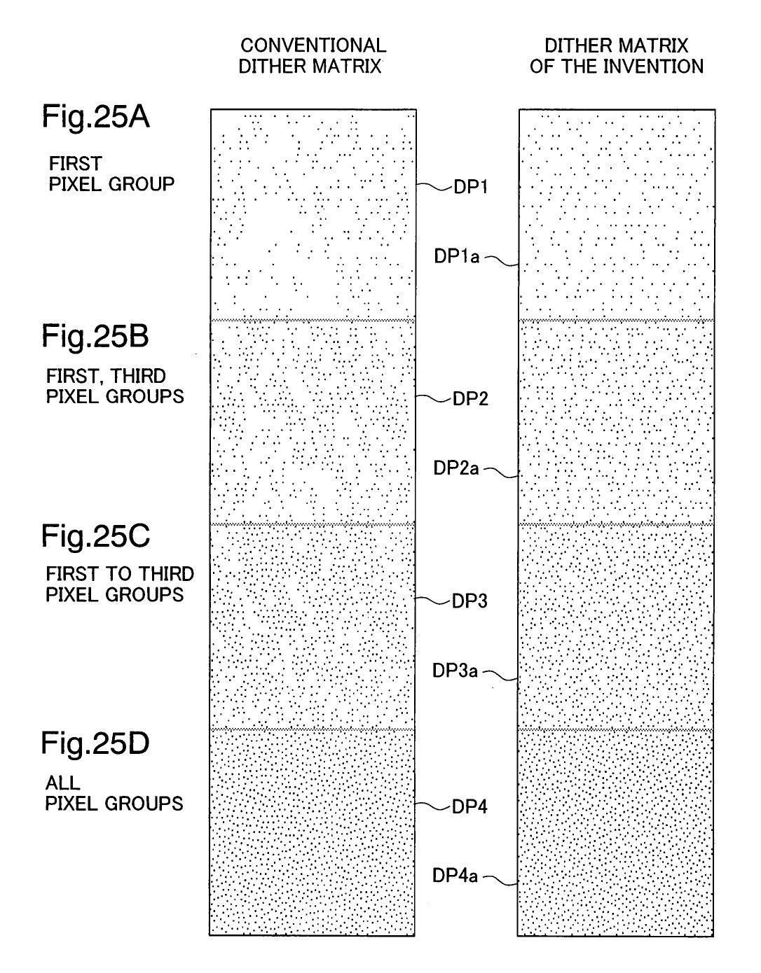

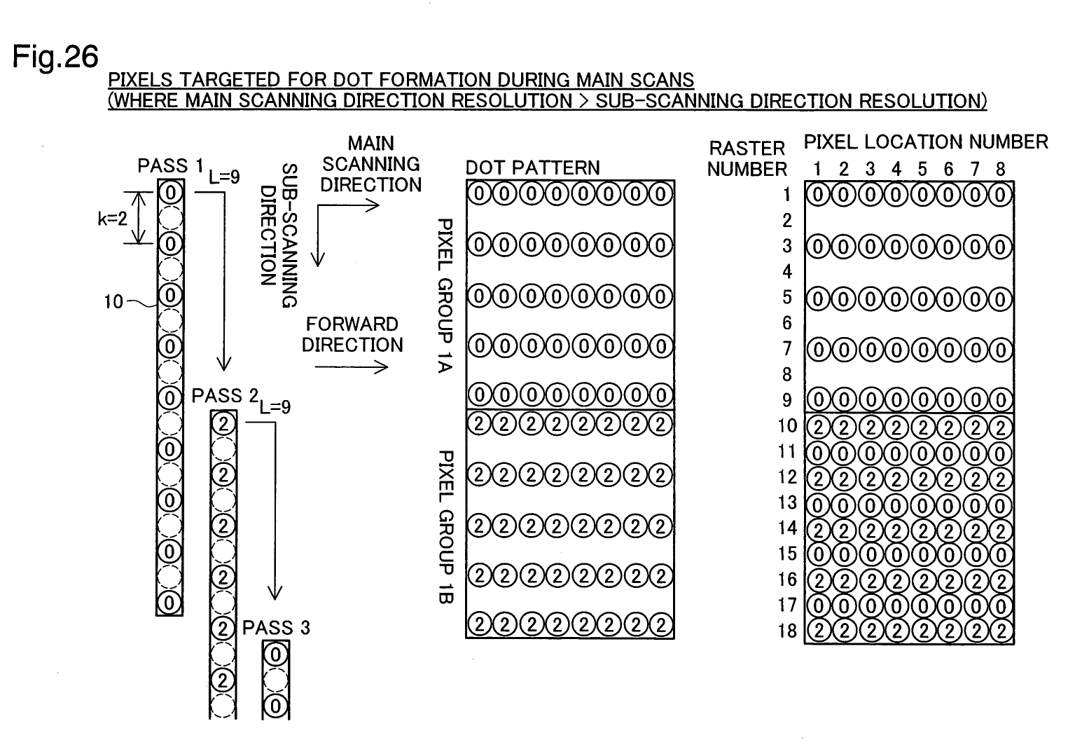

FIGS. 25A to 25D are explanatory drawings showing the state of generating a print image on a print medium by mutually combining on a common print area the dots formed on the print pixels belonging to each of the plurality of pixel groups for the comparative example. With the example of FIG. 25, the print image is the print image of a specified medium gradation (single color) The dot patterns DP1 and DP1a indicate dot patterns formed at a plurality of pixels belonging to the first image group. The dot patterns DP2 and DP2a indicate dot patterns formed on the plurality of pixels belonging to the first and third pixel groups. The dot patterns DP3 and DP3a indicate dot patterns formed on the plurality of pixels belonging to the first to third pixel groups. The dot patterns DP4 and DP4a indicate dot patterns formed on the plurality of pixels belonging to all the pixel groups.

The dot patterns DP1, DP2, DP3, and DP4 are dot patterns when using the dither matrix of the prior art. The dot patterns DP1a, DP2a, DP3a, and DP4a are dot patterns when using the dither matrix of the invention of this application. As can be understood from FIGS. 25A to 25D, when using the dither matrix of the invention of this application, especially with the dot patterns DP1a and DP2a for which there is little dot pattern overlap, the dot dispersibility is more uniform than when using the dither matrix of the prior art.

With the dither matrix of the prior art, optimization is performed focusing only on the dot dispersibility for the finally formed print image (with the example in FIGS. 25A to 25D, dot pattern DP4) because there is no concept of a pixel group. To say this another way, because the dispersibility of dots formed on the pixels belonging to each pixel group is not considered, the dispersibility of dots formed on the pixels belonging to each pixel group is poor, and dot density sparseness occurs.

The dither matrix this application, in addition to the dispersibility of the dots for the print image, also considers up to the dispersibility of the dots formed on the pixels belonging to each pixel group, so the dispersibility of the dots formed on the pixels belonging to each pixel group and the dispersibility of dots for the print image are both improved.

The dither matrix of this application attempts to optimize not only the finally formed dot patterns, but also focuses on dot patterns with the dot forming process. This kind of focus point did not exist in the past. This is because in the past, the technical basic assumption was that even if the dot pattern dispersion was poor with the dot forming process, the image quality was good if the dispersibility of the dot patterns formed at the end were good.

However, the inventors of this application went ahead and performed an analysis of the image quality of print images focusing on the dot patterns with the dot forming process. As a result of this analysis, it was found that image unevenness occurs due to dot pattern sparseness with the dot forming process. This image unevenness was ascertained by the inventors of this application to be strongly perceived by the human eye as ink physical phenomena such as ink agglomeration unevenness, glossiness, or the bronzing phenomenon. Note that the bronzing phenomenon is a phenomenon by which the status of the light reflected by the printing paper surface is changed, such as the printing surface exhibiting a color of a bronze color or the like due to ink drop pigment agglomeration or the like.

For example, the ink agglomeration or bronzing phenomenon can occur even in cases when a print image is formed with one pass. However, even when ink agglomeration or the like occurs uniformly on the entire surface of the print image, it is difficult to be seen by the human eye. This is because since it occurs uniformly, ink agglomeration or the like does not occur as non-uniform “unevenness” including low frequency components.

However, when unevenness occurs with low frequency areas which are easily recognized by the human eye with ink agglomeration or the like for dot patterns formed in pixel groups for which ink dots are formed almost simultaneously with the same main scan, this is manifested as a strong image quality degradation. In this way, when forming print images using ink dot formation, it was first found by the inventors that optimization of the dither matrix focusing also on dot patterns formed in pixel groups for which ink dots are formed almost simultaneously is linked to higher image quality.

In addition, with the dither matrix of the prior art, optimization was attempted with the prerequisite that the mutual positional relationship of each pixel group is as presupposed, so optimality is not guaranteed when the mutual positional relationship is skewed, and this was a cause of marked degradation of the image quality. However, dot dispersibility is ensured even with dot patterns for each pixel group for which mutual positional relationship skew is assumed, so it was first confirmed by experiments of the inventors of the invention of this application that it is possible to also ensure a high robustness level in relation to mutual positional relationship skew.

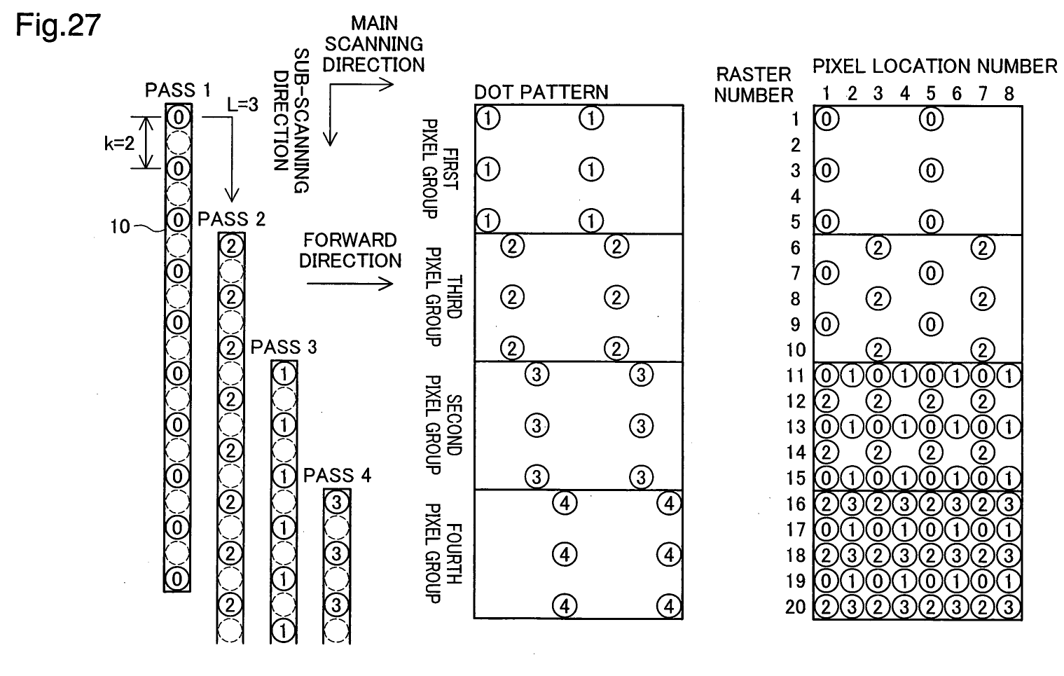

The inventors have found that degradation of picture quality of the sort discussed above is more likely to occur at smaller pitch of the pixels targeted for dot formation during main scans. This is because agglomeration or bronzing are more prone to occur at smaller pitch of the pixels targeted for dot formation during main scans. The inventors have also noted that there are many instances in which the pitch of the pixels targeted for dot formation during main scans differs between the main scanning direction and the sub-scanning direction. In the printing method illustrated in FIG. 26, for example, the pixel pitch discussed above is small in the main scanning direction, while in the sub-scanning direction the pixel pitch is double that in the main scanning direction. In the printing method illustrated in FIG. 27, on the other hand, the pixel pitch discussed above is small in the sub-scanning direction, while in the main scanning direction the pixel pitch is double that in the sub-scanning direction.

In printing methods of this sort, it is possible to optimize the dither matrix by means of carrying out processing similar to Embodiment 1, but substituting the direction of small pixel pitch for the main scanning direction. For example, with the printing method illustrated in FIG. 26, Embodiment 1 may be implemented without modification; while with the printing method illustrated in FIG. 27, Embodiment 1 may be implemented substituting the sub-scanning direction for the main scanning direction.

In this way, even in the case of unidirectional printing whereby dots are formed exclusively in either the forward direction or return direction of main scans of the print head, or in the case where the pixel pitch of pixels targeted for dot formation during main scans differs between the main scanning direction and the sub-scanning direction, the invention herein can nevertheless generate an optimal dither matrix on the assumption of this difference.

### D. Modification Examples

While certain preferred embodiments of the invention have been shown hereinabove, the invention is in no way limited to these particular embodiments, and may be reduced to practice in various other ways without departing from the scope thereof. For example, the invention makes possible optimization of dither matrices for modification examples like the following.

D-1. In the preceding embodiments, the halftoning process is carried out using a dither matrix; however, the invention can also be implemented in cases where the halftoning process is carried out using an error diffusion method, for example. The use of an error diffusion method could be accomplished by performing an error diffusion process for each of the plurality of pixel groups, for example.

Specifically, in addition to the usual error diffusion method, a process of diffusing error could be carried out separately for each of the plurality of pixel groups as well; or weighting of error diffused into pixels belonging to the plurality of pixel groups could be increased. With such arrangements as well, owing to the inherent characteristics of error diffusion methods, it is possible for every dot pattern formed on printing pixels belonging to each of the plurality of pixel groups to have prescribed characteristics at each tone value. Furthermore, by cumulative diffusion in the main scanning direction of error diffused into each of the plurality of pixel groups, dispersion of the dots in each pixel group can be improved with emphasis in the main scanning direction.

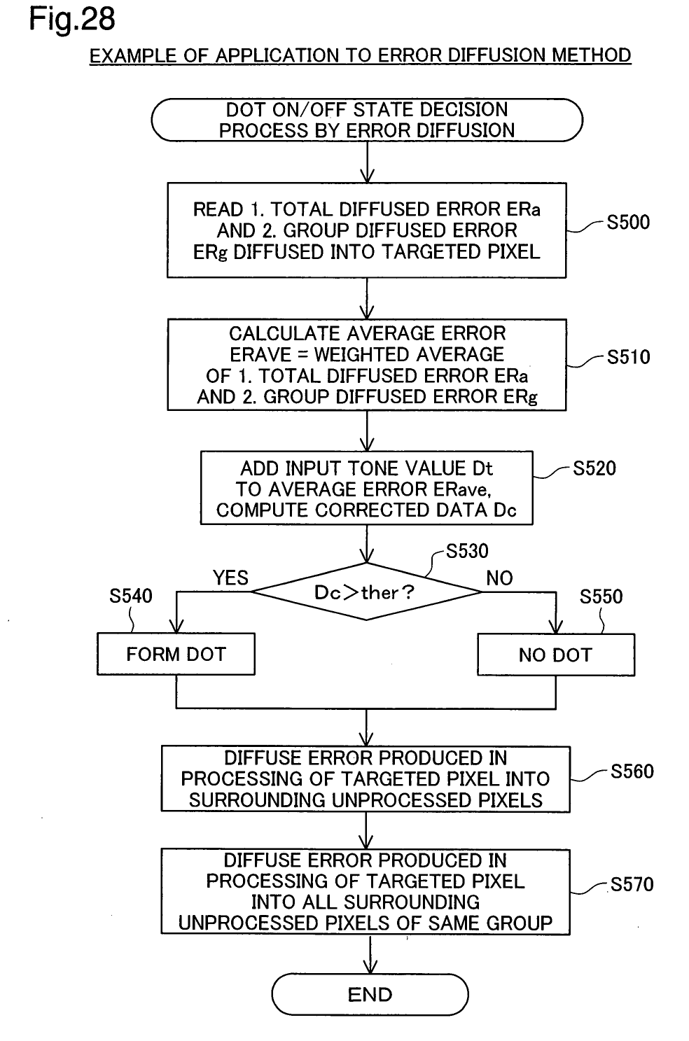

FIG. 28 is an illustration depicting a flowchart of an example of application of the invention in an error diffusion method. The error diffusion method is one type of halftoning process method designed so that difference between input tone values and output tone values is diffused into neighboring pixels, bringing the output tone values into close approximation with the input tone values. In the error diffusion method, dot On/Off states for all printing pixels are determined while shifting, in increments of one, the targeted pixel which is the pixel targeted for determination of dot On/Off state. The typical method of shifting is a method whereby, for example, the targeted pixel is shifted in increments of one in the main scanning direction, and once processing has been completed for all of the pixels in a main scan line, the targeted pixel is then shifted to the adjacent unprocessed main scan line.

In Step S500, the error diffusion that has been diffused into the targeted pixel from a plurality of other pixels which have already been processed is read in. In the present embodiment, error diffusion includes total diffused error ERa and group diffused error ERg.

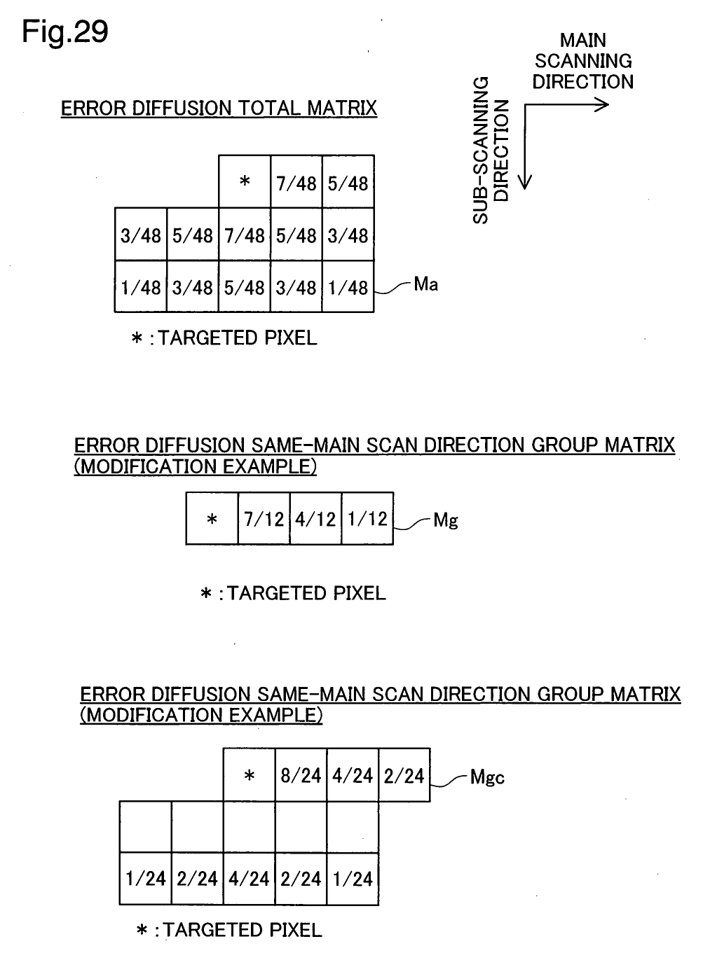

Total diffused error ERa is error that has been diffused using the error diffusion total matrix Ma shown in FIG. 29. In the present embodiment, error is diffused using the commonly known Jarvis, Judice & Ninke error diffusion matrix. Such error diffusion is carried out as typical error diffusion. Like the error diffusion of the conventional art, such error diffusion makes it possible to impart prescribed characteristics to the final dot pattern, by way of an inherent characteristic of error diffusion methods.

In the present embodiment, however, a point of difference from conventional error diffusion methods is cumulative diffusion of group diffused error ERb in order to impart prescribed characteristics to each of two pixel groups 1A, 1B (FIG. 26) as well. This cumulative error diffusion is carried out using an error diffusion total matrix Mg. The “error diffusion same-main scan group matrix Mg” is designed to diffuse error in the main scanning direction only, for the purpose of improving dot dispersion in the main scanning direction. Where it is desired to improve dot dispersion in the sub-scanning direction analogously to the main scanning direction, an error diffusion total matrix Mgc may be used.

In this way, in the present embodiment, error diffusion is carried out in such a way that prescribed characteristics are imparted to the final dot pattern by means of error diffusion using the error diffusion total matrix Ma, and prescribed characteristics are imparted to the respective dot patterns of the plurality of pixel groups by means of error diffusion using the error diffusion same-main scan group matrix Mg.

In Step S510, average error ERave which represents a weighted average of total diffused error ERa and group diffused error ERg is calculated. In the present embodiment, by way of example, total diffused error ERa and group diffused error ERg are assigned weights of “4” and “1” respectively. The average error ERave is calculated as the sum of the value of total diffused error ERa multiplied by the weight “4” plus the value of group diffused error ERg multiplied by the weight “1”, divided by the total sum of the weights “5.”

In Step S520, an input tone value Dt and the average error ERave are added, and corrected data Dc is computed.

In Step S530, the corrected data Dc computed in this way is compared against a predetermined threshold value Thre. If the result of this comparison is that the corrected data Dc is greater than the threshold value Thre, a determination to form a dot is made (Step S540). If on other hand the corrected data Dc is smaller than the threshold value Thre, a determination to not form a dot is made (Step S550).

In Step S560, tone error is computed, and the tone error is diffused into surrounding unprocessed pixels. Tone error is the difference between the tone value of the corrected data Dc and the actual tone value produced by the determination of dot On/Off state. For example, where the tone value of the corrected data Dc is “223” and the actual tone value produced by dot formation is 255, the tone error will be “−32” (=233−255). In this step (S560), error diffusion is carried out using the error diffusion total matrix Ma.

Specifically, for the pixel situated adjacently to the right of the targeted pixel, a value of “−224/48” (=−32×7/48), equivalent to the coefficient “7/48” corresponding to the adjacent right pixel from the error diffusion total matrix Ma multiplied by the tone error of “−32” created by the targeted pixel, will be diffused into the pixel For the two pixels situated adjacently to the right of the targeted pixel, a value of “−160/48” (=−32×5/48), equivalent to the coefficient “5/48” corresponding to the two adjacent right pixels from the error diffusion total matrix Ma multiplied by the tone error of “−32” created by the targeted pixel, will be diffused into the pixels. Like the error diffusion methods of the conventional art, such an error diffusion method imparts prescribed characteristics to the final dot pattern, by way of an inherent characteristic of error diffusion methods.

In Step S570, in a point of difference from conventional error diffusion, cumulative error diffusion is carried out using the error diffusion same-main scan group matrix Mg (FIG. 29). This is done so as to impart prescribed characteristics, particularly in the main scanning direction, to each of two pixel groups 1A, 1B (FIG. 26) as mentioned previously.

In this way, in accordance with the first example of application of the invention to an error diffusion method, the objects of the invention can be attained by means of cumulative error diffusion into the same pixel group as the targeted pixel, with emphasis on the main scanning direction. An arrangement whereby error is diffused all at one time using an error diffusion matrix which combines the error diffusion total matrix Ma and the error diffusion same-main scan group matrix Mg would be acceptable as well.

D-2. In the embodiments discussed previously, storage elements for threshold values are determined sequentially; however, it would also be acceptable, for example, to generate the dither matrix by means of adjustment of a dither matrix from its initial state prepared in advance. For example, a dither matrix having an initial state in which the elements thereof store a plurality of threshold values for the purpose of determining dot On/Off state on a pixel-by-pixel basis depending on input value could be prepared; and then some of the plurality of threshold values stored in the elements could be replaced with threshold values stored at other elements by means of a method determined at random or systematically, adjusting the dither matrix by determining whether or not to make replacements on the basis of evaluation values before and after replacement. The “candidate storage elements” recited in the above embodiment corresponds to the “combinations of a plurality of replaced threshold values” in the present modification example.

D-3. In the preceding embodiments a low pass filter process was carried out and the optimality of a dither matrix was evaluated on the basis of uniformity of dot density and RMS granularity; however, another acceptable arrangement would be, for example, to carry out Fourier transformation on a dot pattern as well as evaluating the optimality of a dither matrix using a VTF function. Specifically, an acceptable arrangement would be to apply the evaluation metric used by Dooley et al. of Xerox (Graininess Scale: GS value) to a dot pattern, and evaluate the optimality of the dither matrix by means of the GS value. Here, the GS value is a graininess evaluation value that can be derived by numerical conversion of the dot pattern carried out by a prescribed process including two-dimensional Fourier transformation, as well as a filter process of multiplying by a visual spatial frequency characteristics VTF followed by integration.

D-4. In the embodiments and modification examples discussed above, the dot On/Off state is determined on a pixel-by-pixel basis by comparing threshold values established in the dither matrix against the tone value of the image data on a pixel-by-pixel basis, it would be acceptable instead to decide dot On/Off states by comparing the sum of the threshold value and tone value to a fixed value, for example. Furthermore, it would be acceptable to decide dot On/Off states depending tone values and on data generated in advance on the basis of threshold values, without using the threshold values directly. In general terms, the dither method of the invention can be any method whereby dot On/Off states are decided with reference to the tone values of pixels and to threshold values established at corresponding pixel locations in the dither matrix.

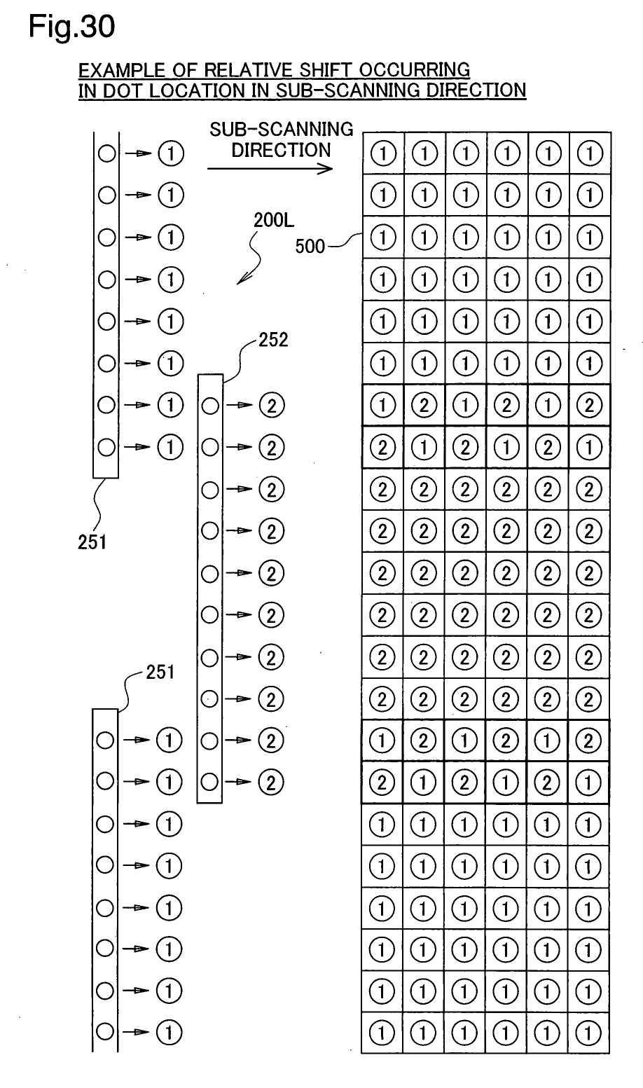

D-5. In the embodiments discussed above, shift of relative position of dots occurs in the main scanning direction; however, there are instances in which shift occurs in the sub-scanning direction, such as with a line printer having the configuration described below, for example. FIG. 30 is an illustration depicting the condition of printing by a line printer 200L having a plurality of print heads 251, 252 in a modification example of the invention. The print heads 251 and the print heads 252 are positioned respectively at multiple locations on the upstream end and the downstream end. The line printer 200L is a printer capable of output at high speed by performing sub-scanning exclusively without performing main scanning.

Shown at the right side of FIG. 30 is a dot pattern 500 formed by the line printer 200L. The numbers 1 and 2 inside the circles indicate that it is the printing head 251 or 252 that is in charge of dot formation. In specific terms, dots for which the numbers inside the circle are 1 and 2 are respectively formed by the printing head 251 and the printing head 252.

Inside the bold line of the dot pattern 500 is an overlap area at which dots are formed by both the printing head 251 and the printing head 252. The overlap area makes the connection smooth between the printing head 251 and the printing head 252, and is provided to make the difference in the dot formation position that occurs at both ends of the printing heads 251 and 252 not stand out. This is because at both ends of the printing heads 251 and 252, the individual manufacturing difference between the printing heads 251 and 252 is big, and the dot formation position difference also becomes bigger, so there is a demand to make this not stand out clearly.

In this kind of case as well, the same phenomenon as when the dot formation position is displaced between the forward scan and the backward scan as described above occurs due to the error in the mutual positional relationship of the printing heads 251 and 252 in the sub-scan direction, so it is possible to try to improve image quality by performing the same process as the embodiment described previously using the pixel position group formed by the printing head 251 and the pixel position group formed by the printing head 252.

D-6. In the embodiments discussed above, optimization of the dither matrix is carried out focusing on the dot patterns formed in the pixel groups; however, it would be possible to carry out optimization by a method such as the following for example, without focusing on such dot patterns.

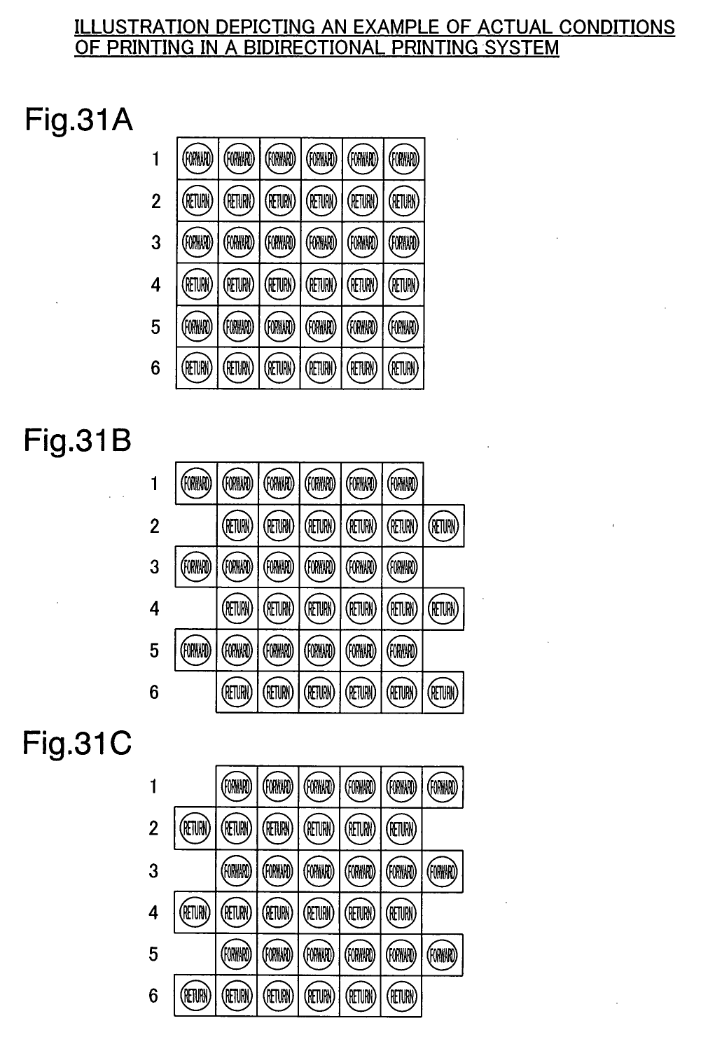

FIGS. 31A to 31C is an explanatory drawing showing an example of the actual printing state for the bidirectional printing method of the third variation example of the invention. The letters in the circles indicate which of the forward or backward main scans the dots were formed with. FIG. 31A shows the dot pattern when displacement does not occur in the main scan direction. FIG. 31B and FIG. 31C show the dot patterns when displacement does occur in the main scan direction.

With FIG. 31B, in relation to the position of dots formed at the print pixels belonging to the pixel position group for which dots are formed during the forward movement of the printing head, the position of the dots formed at the print pixels belonging to the pixel position group for which dots are formed during the backward scan of the printing head is shifted by 1 dot pitch in the rightward direction. Meanwhile, with FIG. 31C, in relation to the position of the dots formed at the print pixels belonging to the pixel position group for which dots are formed during the forward scan of the printing head, the position of the dots formed at the print pixels belonging to the pixel position group for which dots are formed during the backward scan of the printing head is shifted by 1 dot pitch in the leftward direction.

With the embodiments described above, by giving blue noise or green noise spatial frequency distribution to both the dot patterns of the pixel position group for which dots are formed during the forward scan and the dot patterns of the pixel position group for which dots are formed during the backward scan, image quality degradation due to this kind of displacement is suppressed.

In contrast to this, the third variation example is constituted so that the dot pattern for which the dot pattern formed on the pixel position group formed during the forward scan and the dot pattern formed on the pixel position group formed during the backward scan are shifted by 1 dot pitch in the main scan direction and synthesized has blue noise or green noise spatial frequency distribution, or has a small granularity index.

The constitution of the dither matrix focusing on the granularity index can be constituted so that, for example, the average value of the granularity index when the displacement in the main scan direction is shifted by 1 dot pitch in one direction, when it is shifted by 1 dot pitch in the other direction, and when it is not shifted, is a minimum. Alternatively, it is also possible to constitute this such that the spatial frequency distributions in these cases have a mutually high correlation coefficient. The shift amount may be equal or smaller than one dot pitch, and the shift amount may be more than two dot pitch.

Note that this variation example is able to increase the robustness level of the image quality in relation to displacement of the dot formation position during forward scan and backward scan, so it is possible to suppress the degradation of image quality not only in cases when the dot formation positions are shifted as a mass during the forward scan and the backward scan, but also when unspecified displacement occurs with part of the pixel position group for which dots are formed during the forward scan and the pixel position group for which dots are formed during the backward scan. For example, it is possible to suppress degradation of the image quality also in cases such as when there is partial variation in the gap of the printing head and the printing paper between the forward scan and the backward scan due to cyclical deformation due to the main scan of the main scan mechanism of the printing head, for example.

Finally, the present application claims the priority based on Japanese Patent Application No. 2006-074198 filed on Mar. 17, 2006 is herein incorporated by reference.

What is claimed is:

1. A printing method of printing on a print medium, comprising:
performing a halftone process on image data representing a tone value of each of pixels constituting an original image to generate dot data representing a status of dot formation on each of print pixels of a print image to be formed on the print medium; and
generating the print image in response to the dot data, by mutually combining dots formed on print pixels belonging to each of a plurality of pixel position groups in a common print area, the plurality of pixel position groups assuming a physical difference each other at the dot formation, wherein
a condition for the halftone processing is configured such that at least one dot pattern among dot patterns has a given spatial frequency characteristic in a first predetermined specific direction on the printing medium for at least a part of the input tone values, each of the dot patterns being formed on the plurality of printing pixels belonging to each of the plurality of pixel groups.

2. The method according to claim 1, wherein
the condition for the halftone processing is further configured such that each of the dot patterns and a total dot pattern have the given spatial frequency characteristic, the total dot pattern being configured by combining the dot patterns formed on the plurality of printing pixels belonging to each of the plurality of pixel groups.

3. The method according to claim 1, wherein
the at least a part of the input tone values are within a dot density range of from 40% to 60% having a relatively high low-frequency component where uniform placement of dots on the printing medium is assumed.

4. The method according to claim 1, wherein
the given spatial frequency characteristic is a spatial frequency characteristic for which there exists a frequency band in which a given characteristic of spatial frequency of dot patterns formed on printing pixels belonging respectively to the plurality of pixel groups most closely approximates a given characteristic of spatial frequency of dot patterns of the printed image, within a given low-frequency range of a millimeter or less for each four cycles which is the spatial frequency region in which human visual sensitivity is relatively high on a printing medium positioned at a 300 mm viewing distance.

5. The method according to claim 4, wherein
the given spatial frequency characteristic is a graininess evaluation value calculated by a computational process that includes a Fourier transformation process; and
the graininess evaluation value is calculated as a product of a VTF function determined on a basis of visual spatial frequency characteristics, and a constant pre-calculated by the Fourier transformation process.

6. The method according to claim 4, wherein
the given characteristic is RMS granularity computed as a calculation process that includes a low-pass filter process.

7. The method according to claim 1, wherein
the condition for the halftone processing is configured such that the each dot pattern formed on printing pixels belonging to each of the plurality of pixel groups has a predetermined two-dimensional spatial frequency characteristic; and
the two-dimensional spatial frequency characteristic is established such that a one-dimensional spatial frequency characteristic changes according to direction on the printing medium, and in the specific direction the one-dimensional spatial frequency characteristic most closely approximates the spatial frequency characteristic of the printed image.

8. The method according to claim 7, wherein
the two-dimensional spatial frequency characteristic is established such that a rate of change of the one-dimensional spatial frequency characteristic according to direction on the printing medium reaches a peak at an angle in the range of 30° to 60° with respect to the specific direction.

9. The method according to claim 1, wherein
the generating the print includes forming dots on printing pixels during both forward passes and return passes of a print head while carrying out main scanning of the print head;
the plurality of pixel groups include groups of printing pixels targeted for dot formation during forward passes of the print head, and groups of printing pixels targeted for dot formation during return passes of the print head;
the physical differences include a shift of relative position of dots in each of the plurality of pixel groups that occurs caused by main scanning of the print head; and
the specific direction is the main scanning direction.

10. The method according to claim 1, wherein
the generating the print includes forming dots on each of the printing pixels while carrying out main scanning of the print head;
the plurality of pixel groups include groups of a plurality of printing pixels targeted for dot formation during each forward pass of the print head;
the physical differences include lags in timing of dot formation caused by main scanning of the print head; and
the specific direction is the direction of the smallest pitch of printing pixels targeted for dot formation in each main scan of the print head.

11. The method according to claim 1, wherein
the given spatial frequency characteristic is either one of blue noise characteristics and green noise characteristics.

12. A printing apparatus for printing on a print medium, comprising:
a dot data generator that performs a halftone process on image data representing a tone value of each of pixels constituting an original image to generate dot data representing a status of dot formation on each of print pixels of a print image to be formed on the print medium, and
a print image generator that generates the print image in response to the dot data, by mutually combining dots formed on print pixels belonging to each of a plurality of pixel position groups in a common print area, the plurality of pixel position groups assuming a physical difference each other at the dot formation, wherein
a condition for the halftone processing is configured such that at least one dot pattern among dot patterns has a given spatial frequency characteristic in a first predetermined specific direction on the printing medium for at least a part of the input tone values, each of the dot patterns being formed on the plurality of printing pixels belonging to each of the plurality of pixel groups.

13. A computer program product for causing a computer to generate print data to be supplied to a print image generator for generating a print image by forming dots on a print medium, the computer program product comprising:
a computer readable medium; and
a computer program stored on the computer readable medium, the computer program comprising a program for causing the computer to perform a halftone process on image data representing a tone value of each of pixels constituting an original image to generate dot data representing a status of dot formation on each of print pixels of a print image to be formed on the print medium, wherein
the print image is generated in response to the dot data, by mutually combining dots formed on print pixels belonging to each of a plurality of pixel position groups in a common print area, the plurality of pixel position groups assuming a physical difference each other at the dot formation, and
a condition for the halftone processing is configured such that at least one dot pattern among dot patterns has a given spatial frequency characteristic in a first predetermined specific direction on the printing medium for at least a part of the input tone values, each of the dot patterns being formed on the plurality of printing pixels belonging to each of the plurality of pixel groups.
